(19) United States
(12) Patent Application Publication
(10) Pub. No.: US 2022/0059018 A1
(43) Pub. Date: Feb. 24, 2022

(54) TECHNIQUES FOR MITIGATING DISPLAY ARTIFACTS CAUSED BY COMMON VOLTAGE SETTLING ERROR

(71) Applicant: Apple Inc., Cupertino, CA (US)

(72) Inventors: Shatam Agarwal, San Jose, CA (US); Sean C. Chang, Mountain View, CA (US); Hao-Lin Chiu, Campbell, CA (US); Fenghua Zheng, San Jose, CA (US); Pierre-Yves Emelie, Mountain View, CA (US); Yao Chen, Sunnyvale, CA (US); Marc Albrecht, San Francisco, CA (US); Mingxia Gu, San Jose, CA (US); Jun Qi, San Jose, CA (US); Wei Chen, Palo Alto, CA (US)

(21) Appl. No.: 17/406,012

(22) Filed: Aug. 18, 2021

Related U.S. Application Data
(60) Provisional application No. 63/069,007, filed on Aug. 22, 2020.

(51) Int. Cl. G09G 3/32

(52) U.S. Cl. CPC G09G 3/32; G09G 2360/147; G09G 2360/141; G09G 2300/0819; G09G 2360/16; G09G 2340/0457; G09G 2320/0686

(57) ABSTRACT

A light emitting diode (LED) display can calculate a common voltage charge of a line of pixels in the LED display, the common voltage charge comprising a difference between a first line of pixels and a second line of pixels. If the calculated common voltage charge exceeds a predetermined threshold, a toggle matrix can be generated for the line of pixels. The toggle matrix can include a matrix of charge values generated by calculating a difference in charge values for each subpixel a first line of subpixels with each subpixel a second line of subpixels. The LED display can identify one or more regions of subpixels exhibiting the predetermined toggle pattern in the toggle matrix. The LED display can generate a voltage correction charge to apply to affected regions of the display. Alternatively, the subpixels or pixels could be swapped with adjacent pixels to reduce toggling or settling error.

### CROSS-REFERENCES TO RELATED APPLICATIONS

This application claims the benefit of U.S. Provisional Patent Application No. 63/069,007, filed Aug. 22, 2020, entitled “Techniques For Mitigating Display Artifacts Caused By Common Voltage Settling Error” is hereby incorporated by reference in their entirety and for all purposes.

### FIELD

The present disclosure relates generally to electronic display device displays, and more particularly, but not exclusively, to control circuitry for electronic device displays.

### BACKGROUND

Electronic devices such as computers, media players, cellular telephones, set-top boxes, and other electronic equipment are often provided with displays for presenting visual information. Displays such as light emitting diode (LED) displays and liquid crystal displays (LCDs) can include an array of display pixels arrange in pixel rows and pixel columns. Display control circuitry coupled to the array of display pixels typically receives data for display from system control circuitry of the electronic device and, based on the data for display, generates and provides control signals to the array of display pixels. A common supply voltage is typically provided to the display pixels of the array. In certain patterns for toggling voltages to LEDs, the common voltage of the line of LEDs can take time to return to an ideal common voltage. This time for the common voltage to return to the ideal voltage is known as settling time. The delay in returning to the ideal voltage is known as settling error. The common voltage settling error for certain toggling patterns can result in undesirable visual artifacts on portions of the LED display.

### SUMMARY

According to some implementations, a method may include calculating a common voltage charge of a line of pixels in the LED display, the common voltage charge comprising a difference between a first line of pixels and a second line of pixels; determining if the calculated common voltage charge exceeds a predetermined threshold; when the common voltage charge exceeds the predetermined threshold: generating a toggle matrix for the line of pixels, the toggle matrix comprising a matrix of charge values generated by calculating a difference in charge values for each subpixel a first line of subpixels with each subpixel a second line of subpixels wherein the first line of subpixels is adjacent the second line of subpixels; searching the matrix of charge values for a predetermined toggle pattern to identify one or more regions of subpixels exhibiting the predetermined toggle pattern; and generating a voltage correction charge based at least in part on a difference between a common voltage charge and an ideal common voltage charge; and applying the voltage correction charge to the one or more regions of the display in which the subpixels exhibit the predetermined toggle pattern.

According to some implementations, a method may include calculating a common voltage charge of a line of pixels in the LED display, the common voltage charge comprising a difference between a first line of pixels and a second line of pixels; determining if the calculated common voltage charge exceeds a predetermined threshold; when the common voltage charge exceeds the predetermined threshold: generating a toggle matrix for the line of pixels, the toggle matrix comprising a matrix of charge values generated by calculating a difference in charge values for each subpixel a first line of subpixels with each subpixel a second line of subpixels wherein the first line of subpixels is adjacent the second line of subpixels; searching the matrix of charge values for a predetermined toggle pattern to identify one or more regions of subpixels exhibiting the predetermined toggle pattern; and providing commands for rerouting an electrical charge to the one or more subpixels in the identified region of subpixels with the predetermined toggle pattern to a second set of subpixels for a neighboring pixel to the identified region of subpixels.

According to some implementations, a method may include calculating a common voltage charge of a line of pixels in the LED display, the common voltage charge comprising a difference between a first line of pixels and a second line of pixels; determining if the calculated common voltage charge exceeds a predetermined threshold; when the common voltage exceeds the predetermined threshold: generating a toggle matrix for the line of pixels, the toggle matrix comprising a matrix of charge values generated by calculating a difference in charge values for each subpixel a first line of subpixels with each subpixel a second line of subpixels wherein the first line of subpixels is adjacent the second line of subpixels; searching the matrix of charge values for a predetermined toggle pattern to identify one or more regions of subpixels exhibiting the predetermined toggle pattern; and providing commands for rerouting an electrical charge for a pixel comprising one or more subpixels in the identified region of subpixels with the predetermined toggle pattern to a second pixel comprising a second set of subpixels for a neighboring pixel to the identified region.

### BRIEF DESCRIPTION OF THE DRAWINGS

Certain features of the subject technology are set forth in the appended claims. However, for purposes of explanation, several embodiments of the subject technology are set forth in the following figures.

FIG. 1 illustrates a perspective view of an example electronic device implemented in a mobile cellular device having a display in accordance with various aspects of the subject technology.

FIG. 2 illustrates a perspective view of an example electronic device implemented in a tablet computer having a display in accordance with various aspects of the subject technology.

FIG. 3 illustrates a perspective view of an example electronic device implemented in a portable computer having a display in accordance with various aspects of the subject technology.

FIG. 4 illustrates a perspective view of an example electronic device implemented in a wearable device having a display in accordance with various aspects of the subject technology.

FIG. 5 illustrates a perspective view of an example electronic device implemented in a desktop computer having a display in accordance with various aspects of the subject technology.

FIG. 6 illustrates a schematic diagram of an exemplary electronic device having a display in accordance with various aspects of the subject technology.

FIG. 7 shows a schematic diagram of circuitry for monitoring pixel values for monitoring and correcting voltage settling error.

FIG. 8 illustrates an exemplary Z-inversion pattern LED configuration for a display.

FIG. 9 displays an exemplary common voltage trace over time following application of a data signal.

FIG. 10 illustrates an exemplary voltage pattern for a one on and one off LED pattern.

FIG. 11 illustrates a first step for a process for correcting a voltage settling error.

FIG. 12 illustrates a second step for a process for correcting a voltage settling error.

FIG. 13 illustrates the process for generating a toggle matrix.

FIG. 14 is a flow chart of a first exemplary process for techniques for mitigating display artifacts caused by common voltage settling error.

FIG. 15 illustrates an example compensation voltage patterns for a one on and one off LED pattern using a 1 sub-pixel shift.

FIG. 16 illustrates an example compensation voltage patterns for a one on and one off LED pattern using a 1 sub-pixel shift.

FIG. 17 illustrates an example corresponding technique for LED compensation pattern based on the pattern type.

FIG. 18 illustrates a LED display divided into a number of zones.

FIG. 19 illustrates a three-dimensional representation of common voltage settling error for a one on and one off LED pattern.

FIG. 20 illustrates the total correction voltage required for a one on and one off display pattern.

FIG. 21 illustrates a second technique for reducing the voltage settling error.

FIG. 22 is a flow chart of a second exemplary process 2000 for techniques for mitigating display artifacts caused by common voltage settling error.

FIG. 23 illustrates a third technique for reducing the voltage settling error.

FIG. 24 is a flow chart of a third exemplary process for techniques for mitigating display artifacts caused by common voltage settling error.

FIG. 25 illustrates a fourth technique for compensating for voltage settling error.

FIG. 26 is a flow chart of a fourth exemplary process for techniques for mitigating display artifacts causes by common voltage settling error.

FIG. 27 is a block diagram of an example electronic device employing the techniques disclosed herein.

### DETAILED DESCRIPTION OF THE DRAWINGS

The following detailed description of example implementations refers to the accompanying drawings. The same reference numbers in different drawings may identify the same or similar elements.

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The subject disclosure provides electronic devices such as cellular telephones, media players, computers, wearable computing devices, set-top boxes, wireless access points, and other electronic equipment that may include displays. Displays may be used to present visual information and status data and/or may be used to gather user input data. A display may include an array of display pixels. Each display pixel may include one or more colored subpixels for displaying color images.

For example, an electronic device may include a display having an array of display pixels. Each display pixel may include a pixel circuit having components such as thin-film transistors (TFTs) that are operable to control a light-emitting component such as an organic light-emitting diode (OLED) or other light-control components such as a portion of a liquid crystal layer of a display that controls passage of light from a backlight for the display.

A common voltage (VCOM) is supplied to the pixels of the pixel array via VCOM circuitry (e.g., a supply line mesh coupled to all of the pixels of the array). As the display pixels of each row are operated (e.g., illuminated) with differing pixel voltages (to illuminate the display based on different pixel values), the VCOM circuitry sources or sinks current to maintain the common voltage.

In accordance with various aspects of the subject disclosure, systems and methods for eliminating or reducing the visual artifacts created by common voltage settling errors in the display are disclosed. For example, and as described in further detail hereinafter, VCOM current may be adjusted by analyzing the difference in pixel values between each pair of adjacent pixel rows and modifying the values of a current pixel row to prevent row-to-row changes above a threshold.

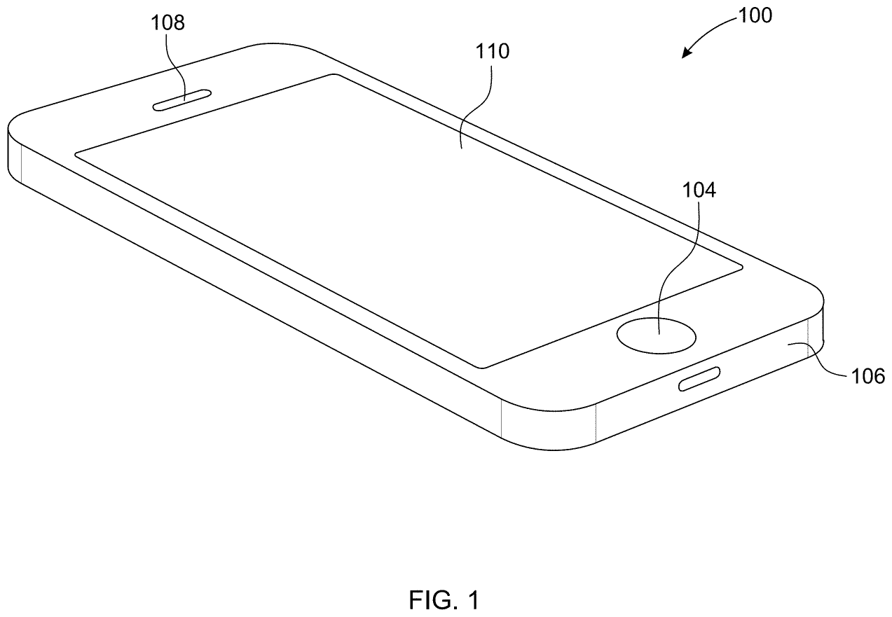

An illustrative electronic device having a display is shown in FIG. 1. In the example of FIG. 1, device 100 has been implemented using a housing that is sufficiently small to fit within a user's hand (e.g., device 100 of FIG. 1 may be a handheld electronic device such as a cellular telephone). As shown in FIG. 1, device 100 includes a display such as display 110 mounted on the front of housing 106. Display 110 may be substantially filled with active display pixels or may have an active portion and an inactive portion. Display 110 may have openings (e.g., openings in the inactive or active portions of display 110) such as an opening to accommodate button 104 and an opening to accommodate speaker port 108.

Display 110 may be a touch screen that incorporates capacitive touch electrodes or other touch sensor components or may be a display that is not touch-sensitive. Display 110 includes display pixels. The display pixels may be formed from light-emitting diodes (LEDs), organic light-emitting diodes (OLEDs), plasma cells, electrophoretic display elements, electro wetting display elements, liquid crystal display (LCD) components, or other suitable display pixel structures. Arrangements in which display 110 is formed using organic light-emitting diode pixels and liquid crystal display pixels are sometimes described herein as an example. This is, however, merely illustrative. In various implementations, any suitable type of display technology may be used in forming display 110, if desired.

Housing 106, which may sometimes be referred to as a case, may be formed of plastic, glass, ceramics, fiber composites, metal (e.g., stainless steel, aluminum, etc.), other suitable materials, or a combination of any two or more of these materials.

The configuration of electronic device 100 of FIG. 1 is merely illustrative. In other implementations, electronic device 100 may be a computer such as a computer that is integrated into a display such as a computer monitor, a laptop computer, a tablet computer, a somewhat smaller portable device such as a wrist-watch device, pendant device, or other wearable or miniature device, a media player, a gaming device, a navigation device, a computer monitor, a television, or other electronic equipment.

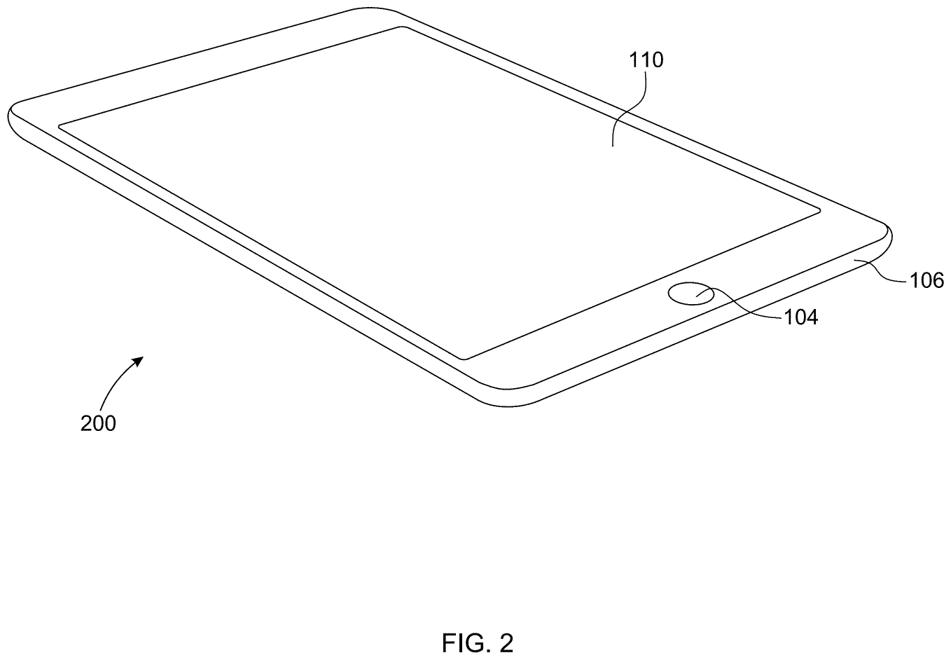

For example, FIG. 2 is a perspective view of electronic device 200 in a configuration in which electronic device 100 shown in FIG. 1 has been implemented in the form of a tablet computer. In the example of FIG. 2, display 110 is mounted on the upper (front) surface of housing 106. An opening may be formed in display 110 to accommodate button 104.

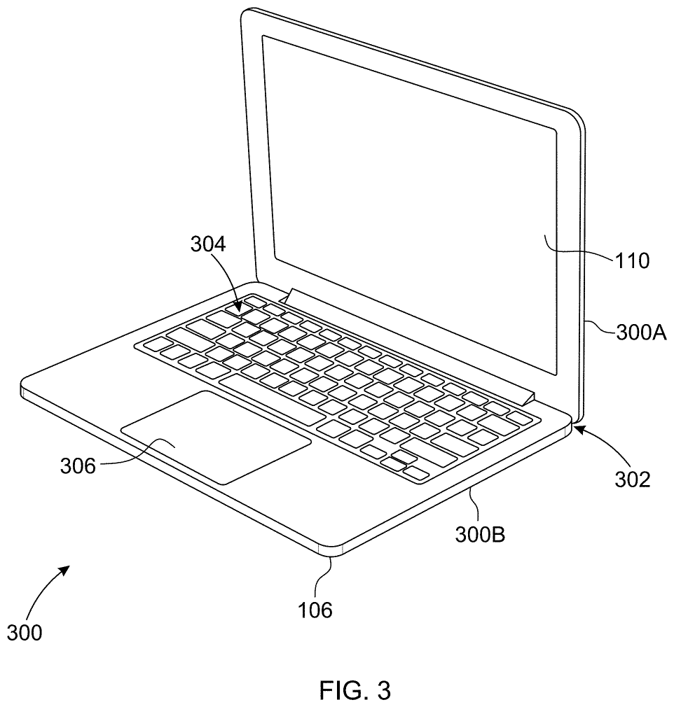

As another example, FIG. 3 is a perspective view of electronic device 300 in a configuration in which electronic device 100 shown in FIG. 1 has been implemented in the form of a portable computer. In the example of FIG. 3, housing 106 may be formed using a unibody configuration in which some or all of housing 106 is machined or molded as a single structure or may be formed using multiple structures (e.g., an internal frame structure, one or more structures that form exterior housing surfaces, etc.).

As shown in FIG. 3, housing 106 may have multiple parts. For example, housing 106 may have upper portion 300A and lower portion 300B. Upper portion 300A may be coupled to lower portion 300B using a hinge that allows portion 300A to rotate about rotational axis 302 relative to portion 300B. A keyboard such as keyboard 304 and a touch pad such as touch pad 306 may be mounted in lower housing portion 300B, in some implementations.

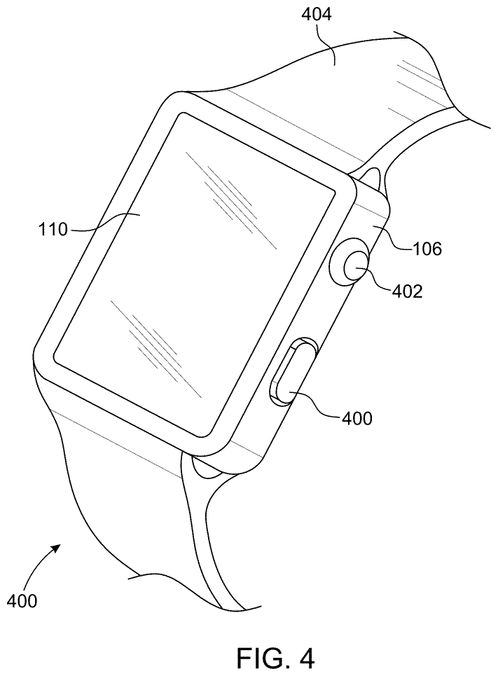

FIG. 4 is a perspective view of electronic device 400 in a configuration in which electronic device 400 has been implemented in the form of a wearable device 400 such as wristwatch device. In the example of FIG. 4, display 110 is mounted on a front surface of housing 106. Housing 106 may include one or more openings, such as sidewall openings in which one or more corresponding input/output components are disposed. In the example of FIG. 4, a compressible side button 400 and a compressible/rotatable crown button 402 are provided by which a user can operate device 100. Strap 404 may be coupled to housing 106 and arranged to secure device 100 to a part of a user's body such as around the user's wrist.

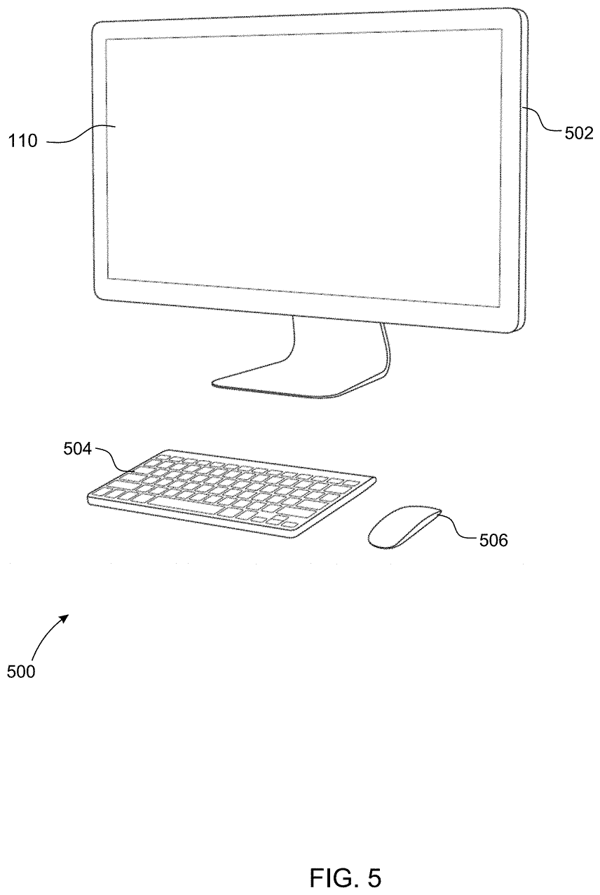

FIG. 5 illustrates a perspective view of an example electronic device 500 implemented in a desktop computer 500 having a display 110 in accordance with various aspects of the subject technology. In the example of FIG. 5, display 110 is connected to one or more processors and one or more memories contained within a housing 502 of the display 110. The desktop computer 500 can include a keyboard 504 and a pointing device 506 (e.g., a mouse).

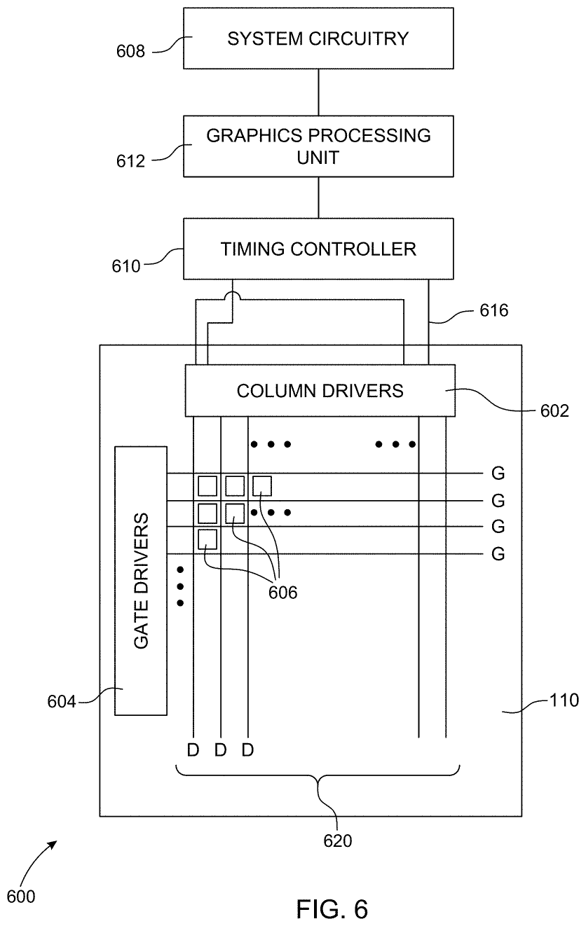

FIG. 6 is a schematic diagram of device 600 showing illustrative circuitry that may be used in displaying images for a user of device 100 on pixel array 620 of display 110. In the example of FIG. 6, display 110 includes column driver circuitry 602 that drives data signals (analog voltages) onto the data lines D of array 620. Gate driver circuitry 604 drives gate line signals onto gate lines G of array 620.

Using the data lines D and gate lines G, display pixels 606 are operated to display images on display 110 for a user. Operating a display pixel may include illuminating an LED of the display pixel or rotating the liquid crystals of a liquid crystal layer to allow backlight to pass through the liquid crystal layer. In some implementations, gate driver circuitry 604 may be implemented using thin-film transistor circuitry on a display substrate such as a glass or plastic display substrate or may be implemented using integrated circuits that are mounted on the display substrate or attached to the display substrate by a flexible printed circuit or other connecting layer. In some implementations, column driver circuitry 602 may be implemented using one or more column driver integrated circuits that are mounted on the display substrate or using column driver circuits mounted on other substrates.

Device 100 includes control circuitry. The control circuitry includes system circuitry 608 and display control circuitry such as graphics processing unit 612, and timing controller 610. During operation of device 600, system circuitry 608 produces data that is to be displayed on display 110. This display data is provided to display control circuitry such as timing controller integrated circuit 610 using graphics processing unit 612.

Timing controller (TCON) 610 provides digital display data, such as display pixel values for each display pixel, to column driver circuitry 602 using paths 616. Column driver circuitry 602 receives the digital display data from timing controller 610. Using digital-to-analog converter circuitry within column driver circuitry 602, column driver circuitry 602 provides corresponding analog output signals on the data lines D running along the columns of display pixels 606 of array 620.

Timing controller 610, column drivers 602, and gate drivers 604 may sometimes collectively be referred to herein as display control circuitry. Display control circuitry can be used in controlling the operation of display 110. Display control circuitry can be implemented, in some configurations, in a common package such as a display driver, a display controller, a display driver integrated circuit (IC), or a driver IC. Graphics processing unit 612, when included in the display control circuitry, performs image or other graphics processing on display data received from system circuitry 608 prior to providing the display data to display control circuitry for display using pixels 606 of array 620. Graphics processing unit 612 may be a separate processing controller from system circuitry associated with system circuitry 608 or may be implemented as a part of system circuitry 608 (e.g., in a common SOC).

Although a signal gate/scan line G and a single data line D for each pixel 606 are illustrated in FIG. 6, this is merely illustrative and one or more additional row-wise and/or column-wise control lines and/or supply lines may be coupled to each pixel 606 in various implementations. For example, a voltage supply mesh may be provided that is coupled to each of display pixels 606 and to a common supply voltage (VCOM) source. Gate drivers 604 select pixels 606 on a pixel row by pixel row basis, sequentially enabling the pixels 606 of a particular row for illumination. The illumination of the individual pixels in each row is controlled based on display data including display pixel values for each pixel (e.g., each colored sub pixel) in that row. Selecting the pixels of a pixel row and illuminating the individual pixels (e.g., by illuminating an LED or allowing backlight to pass through a liquid crystal layer) according to a display pixel value for each pixel is sometimes described herein as operating the display pixels.

Because the pixel values for the pixels each row are often different, the current sourced or sinked by the VCOM mesh changes with the operation of each pixel row. In order to limit the amount of VCOM current generated by the changing pixel values from row-to-row, the pixel values for each pixel row are monitored and may be modified to prevent a VCOM current above a threshold.

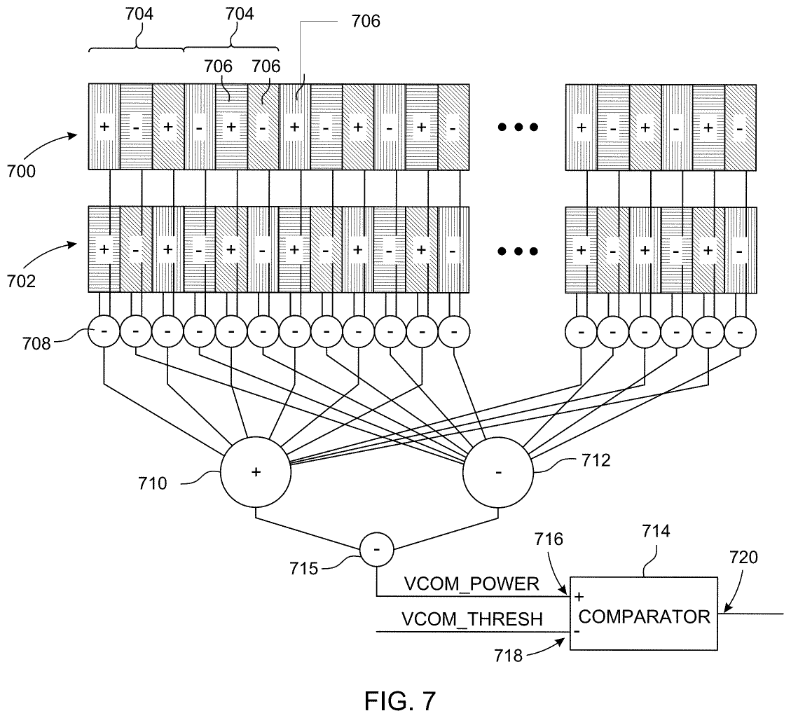

FIG. 7 shows a schematic diagram of circuitry for monitoring pixel values for monitoring and correcting voltage settling error. FIG. 7 illustrates pixel values for a previous pixel row 700 and for a current pixel row 702. The display pixels of previous pixel row 700 are operated using the display pixel values shown. As shown, the pixel values for previous pixel row 700 may include subpixel values 706 for each of the display pixels 704 in that row. FIG. 7 also indicates that the pixel values of each pixel row may have a positive (+) polarity or a negative (−) polarity.

During operation of a display such as display 110, a corresponding common polarity pair of subpixel values, one each in previous row 700 and current row 702, are provided to a corresponding difference circuit 708 that determines the difference between those two pixel values. The subpixel differences for each pair of positive polarity pixel values are accumulated by a first accumulator 710. The subpixel differences for each pair of negative polarity pixel values are accumulated by a second accumulator 712. The accumulated differences from first accumulator 710 and second accumulator 712 are combined, by adder circuit 715, to determine a total differential VCOM power. The total differential VCOM power is provided from adder circuit 715 to a first input terminal 716 of comparator 714. A threshold VCOM power is provided to a second input terminal 718 of comparator 714. An output signal from comparator 714 is provided at output terminal 720. If the total differential VCOM power is greater than the threshold VCOM power, the output signal of comparator 714 enables VCOM settling error mitigation operations. If the total differential VCOM power is less than (or equal to) the threshold VCOM power, the output signal of comparator 714 disables or bypasses VCOM settling error mitigation operations.

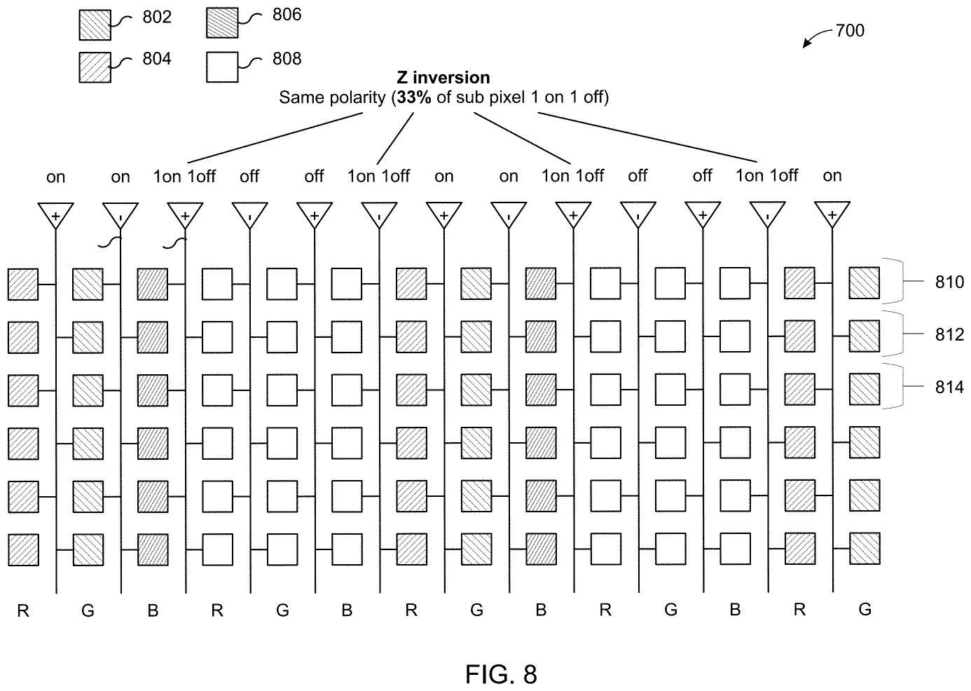

FIG. 8 illustrates an exemplary Z-inversion pattern LED configuration for a display. The configuration illustrated in FIG. 8 is a one pixel one, one pixel off configuration. As shown in FIG. 8, each pixel can be comprised on three subpixels. For example, the subpixels can include a red subpixel 802, a blue subpixel 804, and a green subpixel 808. Other colored subpixels or other pixel and/or subpixel patterns can be configured in the LED display. As shown in the pattern illustrated in FIG. 8, several pixels and hence subpixels are off. This results in several off subpixels 808. FIG. 8 illustrates an exemplary pattern how the subpixels are hardwired and connected to each other in the LED display.

In a Z-inversion type LED display system a Thin Film Transistor (TFT) and a pixel electrode (P) are alternately disposed on left and right of data lines, and a data voltage is provided to the data lines in a column inversion type. That is, the Z-inversion type is an enhanced structure of the column inversion type in which a circuit driving method of the Z-inversion type uses the column inversion, but a screen display is implemented in the same manner as the dot inversion type (i.e., the dot inversion system) by forming TFTs of a liquid crystal panel in an opposite direction with respect to each line.

In the LED pattern illustrated in FIG. 8, the first data line 810 does not toggle because it is connected to red subpixels 802 and green subpixels 804 on the second data line 812 and both red subpixels 802 and green subpixels 804 are high voltages so there is no toggling involved. For example, the second red subpixel 802 in the second data line 812 is connected to the off subpixel 808 (black subpixel) on the first data line 810. The next red subpixel 802 on the second data line 812 is also connected to an off subpixel 808. On the third data line 814 there is one subpixel on and one subpixel off because that particular data line toggles every line because it is connected to blue subpixels 806 on the first line 810 but it is connected to black for the next line. The third data line 814 toggles between like +/−5 volts. This can be known as basic toggling. Because the toggling occurs with subpixels that all have the same polarities then there is an imbalance that builds up in the VCOM voltage.

The toggling of the voltages on the data line can result disturbance on the VCOM plane. Because of this particular pattern and the toggling there is a settling error on VCOM because like the there is a disturbance and it the data line does not get enough time to settle back to the ideal VCOM voltage. This produces an error in the VCOM resulting in the effective red and the blue voltages on the pixel becomes smaller and the green voltage becomes larger resulting in a green tint on the display.

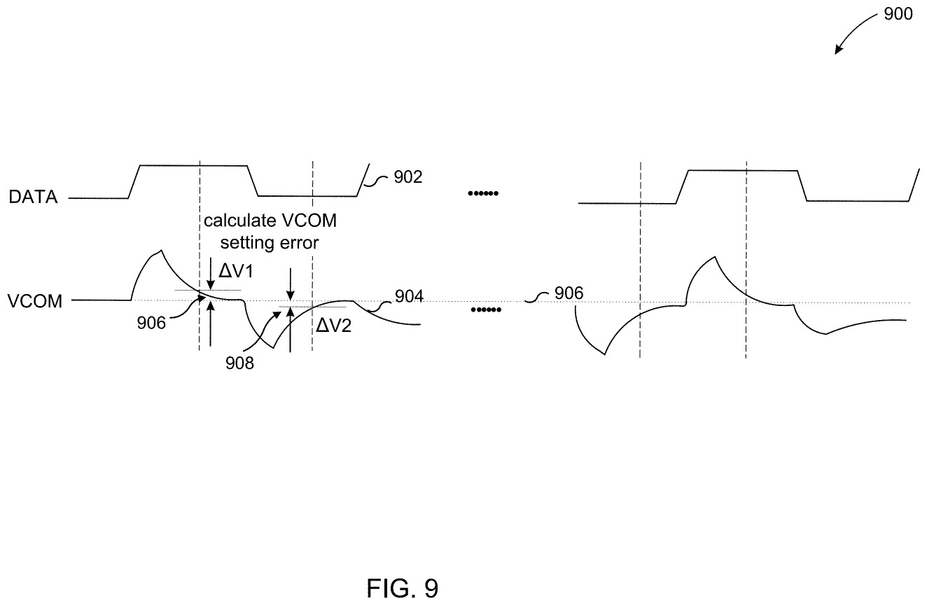

FIG. 9 displays an exemplary common voltage (VCOM) trace 900 over time following application of a data signal 902. As shown in FIG. 9, following application of the data signal 902, the common voltage 904 deviates from an ideal common voltage 906. As it takes time for the common voltage 904 to return to the ideal common voltage 906 there can be either a positive voltage settling error 906 or a negative voltage settling error 908. With a positive voltage settling error, all the positive subpixels will be effectively dimmer because the VCOM is not zero anymore but some positive value. With a positive voltage settling error, all the negative subpixels (here, the green subpixels 804, shown in FIG. 8) have a higher effective voltage across the green subpixels 804. This results in the red subpixels 802, shown in FIG. 8, and the blue subpixels 806, shown in FIG. 8, being dimmer and the green subpixels 804 being brighter.

While the one on, one off pattern is discussed at length other patterns can cause such voltage settling errors. For example, one on and three off and three on and three off can also result in voltage settling errors that can produce undesirable visual artifacts on the display.

Similar LED patterns that that are shifted to the right by one subpixel that can result in a one on one off pattern but the color that is boosted is not green anymore, but would be blue. By shifting by two subpixels, the color that is boosted would be red.

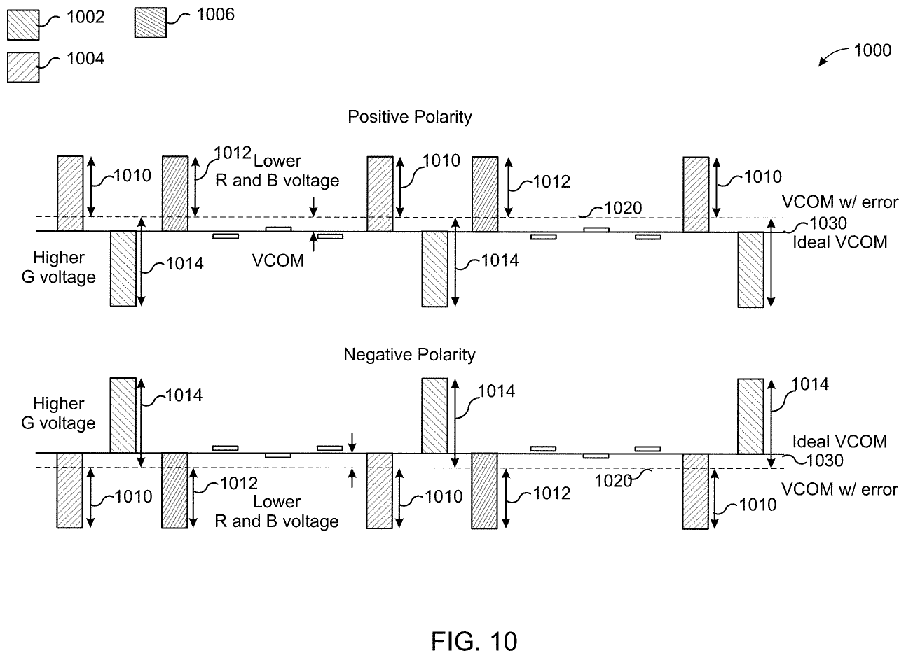

FIG. 10 illustrates an exemplary voltage pattern 1000 for a one on and one off LED pattern. As shown in FIG. 10 the red subpixel voltage 1010 for the red subpixels 1002 and the blue subpixel voltage 1012 for the blue subpixels 1006 can have positive polarity and the green subpixel voltage 1014 for the green subpixels 1004 can have negative polarity. As the red subpixel voltage 1010 and blue subpixel voltage 1012 have lower voltages than the green subpixel voltage 1014, the voltage settling error 1020 can result in a lower effective red subpixel voltage 1010 and blue subpixel voltage 1014 resulting in a larger green subpixel voltage 1012. This can result in an undesirable green tint on the display.

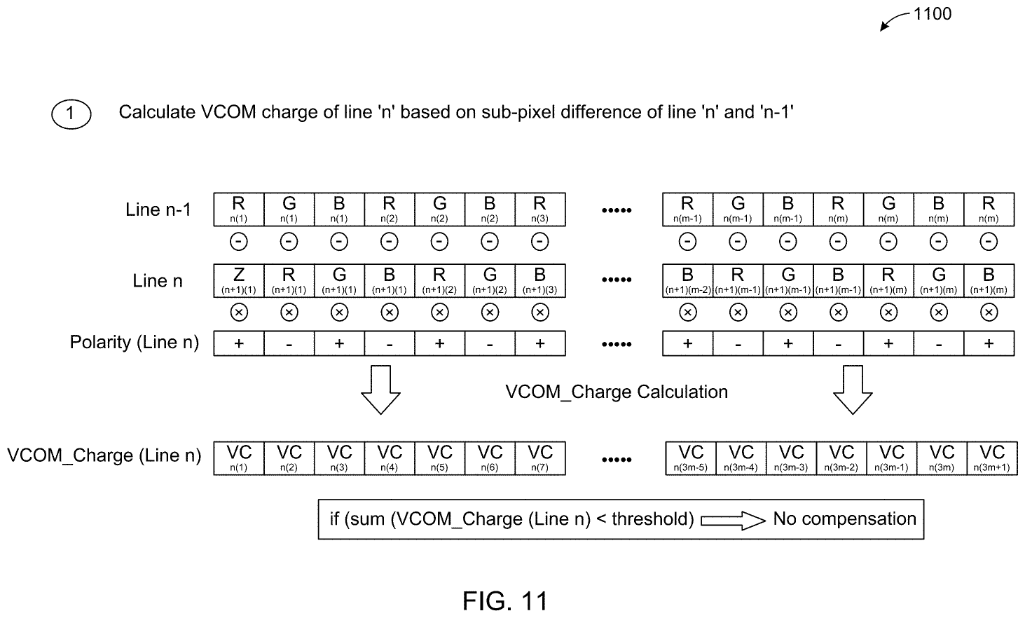

FIG. 11 illustrates a first step for a process 1100 for correcting a voltage settling error. The first step can include calculating a common voltage for a line of pixels by calculating a difference in voltage between adjacent horizontal lines (e.g., line n and line n−1) of subpixels of a LED display. The first step of the process 1100 is to determine if the VCOM charge for the line exceeds a threshold voltage. In various embodiments, the threshold voltage can be between +5 volts and −5 volts. If the common voltage exceeds the threshold voltage, correction will need to be applied. If the common voltage does not exceed the threshold voltage no correction is necessary for that line of LEDs. The common voltage can be calculated for every horizontal line of pixels for the display.

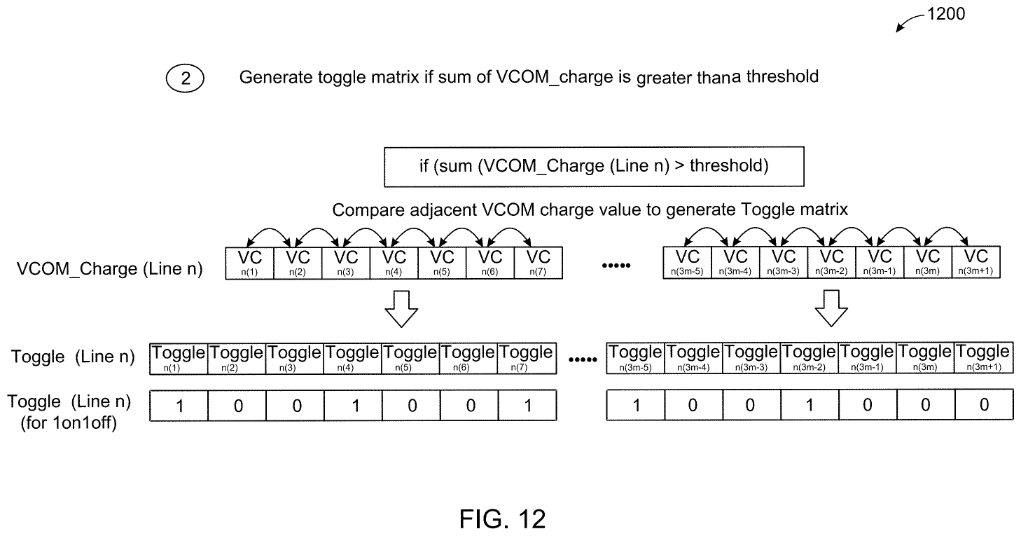

FIG. 12 illustrates a second step for a process 1000 for correcting a voltage settling error. The second step can include comparing adjacent VCOM charge values to generate a toggle matrix. The toggle matrix is used to determine which subpixels are contributing to the voltage settling error. The voltage on VCOM can be toggled as the polarity of the voltage applied to the data line switches. However, the voltage on VCOM is toggled in the opposite direction to the polarity change of the voltage on the data line. For example, when the polarity of the voltage on the data line switches from positive to negative, the voltage on VCOM can be self-converted to positive voltage. When the polarity of the voltage on the data line switches from negative to positive, the voltage on VCOM can be toggled to negative voltage.

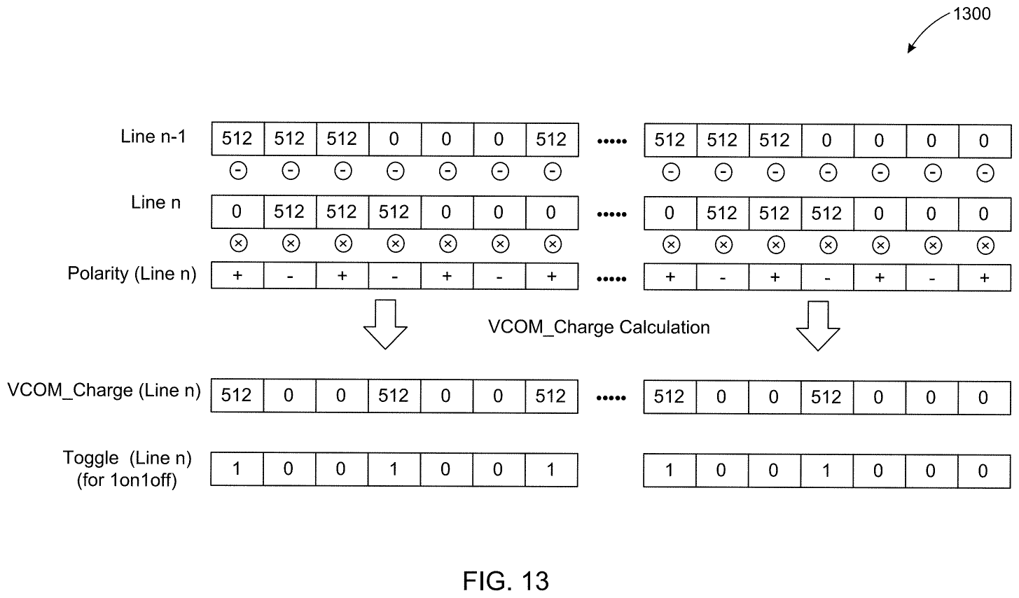

FIG. 13 illustrates the process 1300 for generating a toggle matrix. For each subpixel, the process will determine if a toggle occurs. A toggle occurs if the delta between adjacent subpixels is greater than a particular threshold. For example, if the first subpixel is off (0) to full common voltage in the subpixel adjacent to the first subpixel, then the toggle will be one. For example, as shown in FIG. 13, first subpixel for Line n−1 has a value of 512 and the first subpixel of Line n is zero producing a different of 512 resulting in a toggle value of one. In the second column, the second subpixel in Line n−1 has a value of 512 and the second subpixel of Line n also has a value of 512 producing a difference between these subpixel values of zero resulting in a toggle value of zero (0). In the third column, the difference in subpixel values between Line n−1 and Line n is also zero (0) resulting in a toggle value of zero (0). In the fourth column, the subpixel value in Line n−1 is 0 and the subpixel value in Linen is 512 resulting in a difference of 512, resulting in a toggle value of one (1). The process 1300 is completed for all lines in which the common voltage settling error exceeds a threshold. The toggling matrix can be stored in a memory of the display.

Returning to FIG. 12, the toggle matrix is illustrated for a one on and one off matrix. This can result in a toggle pattern of [100100] pattern in the toggle matrix. Other toggle patterns may result in visual artifacts that need to be corrected. This specific toggle pattern of [100100] can cause the undesirable visual artifact and informs the system of the subpixels in the display in which corrective voltages can be applied, or subpixels or pixels swapped. The next step is to identify the regions by subpixel in each line of LEDs in the display that exhibit this specific pattern. Once those regions are identified, the subpixel locations can be stored to memory for applying one of the corrections described below.

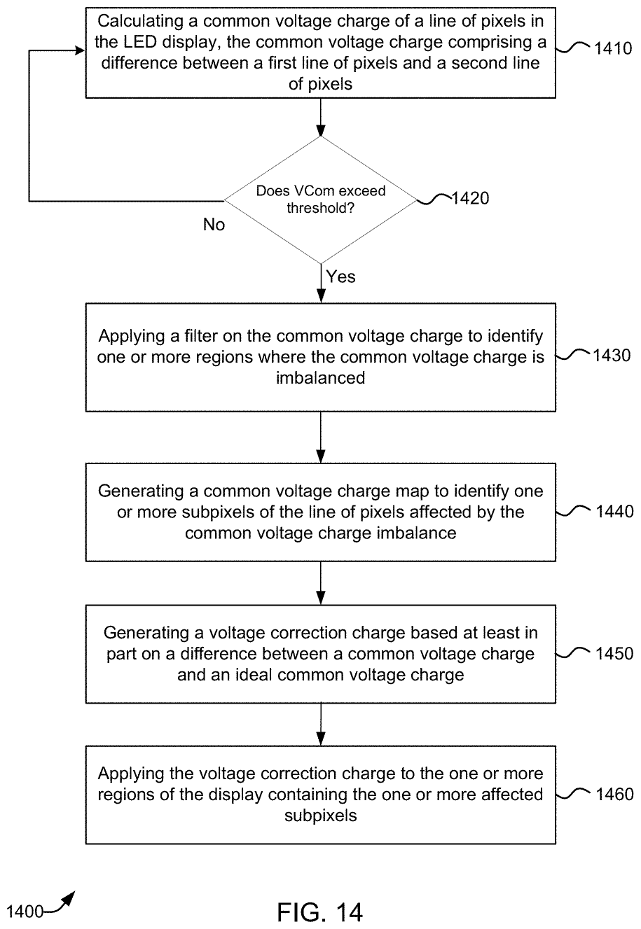

FIG. 14 is a flow chart of an example process 1400 for techniques for mitigating display artifacts caused by common voltage settling error. In some implementations, one or more process blocks of FIG. 14 can be performed by a display control system. In some implementations, one or more process blocks of FIG. 14 can be performed by another device or a group of devices separate from or including the display control system.

At 1410, process 1400 can include calculating a common voltage charge of a line of pixels in the LED display, the common voltage charge comprising a difference between a first line of pixels and a second line of pixels. For example, the display control system (e.g., using system circuitry 608, a graphics processing unit 612, a timing controller 614, column drivers 602 and gate drivers 603 and/or the like as illustrated in FIG. 6 and described above) can calculate a common voltage charge of a line of pixels in the LED display, the common voltage charge comprising a difference between a first line of pixels and a second line of pixels, as described above.

At 1420, process 1400 can include determining if the calculated common voltage charge exceeds a predetermined threshold. For example, the display control system (e.g., a comparator 614 and/or the like as illustrated in FIG. 6 and described above) can determine if the calculated common voltage charge exceeds a predetermined threshold, as described above.

At 1430, process 1400 can include when the common voltage charge exceeds the predetermined threshold: applying a filter on the common voltage charge to identify one or more regions where the common voltage charge is imbalanced.

In various embodiments, the process 1400 can include generating a toggle matrix for the line of pixels, the toggle matrix comprising a matrix of charge values generated by calculating a difference in charge values for each subpixel a first line of subpixels with each subpixel a second line of subpixels, and wherein the first line of subpixels is adjacent the second line of subpixels. For example, the display control system (e.g., using system circuitry 608, a graphics processing unit 612, a timing controller 614, column drivers 602 and gate drivers 603 and/or the like as illustrated in FIG. 6 and described above) can when the common voltage charge exceeds the predetermined threshold, as described above. In some implementations, the first line of subpixels is adjacent the second line of subpixels.

At 1440, process 1400 can include searching the matrix of charge values for a predetermined toggle pattern to identify one or more regions of subpixels exhibiting the predetermined toggle pattern. For example, the display control system (e.g., using system circuitry 608, a graphics processing unit 612, a timing controller 614, column drivers 602 and gate drivers 603 and/or the like as illustrated in FIG. 6 and described above) can search the matrix of charge values for a predetermined toggle pattern to identify one or more regions of subpixels exhibiting the predetermined toggle pattern, as described above. The predetermined toggle pattern can be [100100]. The coordinates of the subpixels exhibiting this pattern can be stored in memory.

At 1450, process 1400 can include generating a voltage correction charge based at least in part on a difference between a common voltage charge and an ideal common voltage charge.

For example, the display control system (e.g., using system circuitry 608, a graphics processing unit 612, a timing controller 614, column drivers 602 and gate drivers 603 and/or the like as illustrated in FIG. 6 and described above) can generate a voltage correction charge based at least in part on a difference between a common voltage charge and an ideal common voltage charge, as described above.

In various embodiments, generating the voltage correction charge can include calculating a segment scaling factor (Cf). The scaling can be based on the total common voltage charge in the segment. The segment scaling factor can be calculated using the following formula:

$$Cf ( seg ) = {Cf}_{0} * \frac{\vert Seg - VCOM ( seg ) \vert}{vcom \_ seg \_ ref}$$

In various embodiments, the correction voltage LUT can be calculated by segment-wise superposition of CR_matrix using the following formula:

$${Correction}_{LUT} = {\sum }_{i = 1}^{seg} {CR}_{matrix} * Cf ( i ) * sign ( {Seg}_{vcom ( i )} )$$

In various embodiments, a Correction_LUT Interpolator can be used to get correction (n,m) by bilinear interpolating Correction_LUT based on pixel location (n,m). The formula for the correction voltage can be expressed as follows:

correction_{voltage}(n, m, ch)=correction(n, m)*polarity(n, m, ch)

At 1460, process 1400 can include applying the voltage correction charge to the one or more regions of the display in which the subpixels exhibit the predetermined toggle pattern. For example, the display control system (e.g., using system circuitry 608, a graphics processing unit 612, a timing controller 614, column drivers 602 and gate drivers 603 and/or the like as illustrated in FIG. 6 and described above) can apply the voltage correction charge to the one or more regions of the display in which the subpixels exhibit the predetermined toggle pattern, as described above. The voltage correction charge can be added to the red and blue subpixels to compensate for the VCOM settling error.

Process 1400 can include additional implementations, such as any single implementation or any combination of implementations described below and/or in connection with one or more other processes described elsewhere herein. It should be appreciated that the specific steps illustrated in FIG. 14 provide particular techniques for techniques for mitigating display artifacts caused by common voltage settling error according to various embodiments of the present disclosure. Other sequences of steps can also be performed according to alternative embodiments. For example, alternative embodiments of the present disclosure can perform the steps outlined above in a different order. Moreover, the individual steps illustrated in FIG. 14 can include multiple sub-steps that can be performed in various sequences as appropriate to the individual step. Furthermore, additional steps can be added or removed depending on the particular applications. One of ordinary skill in the art would recognize many variations, modifications, and alternatives.

In some implementations, process 1400 includes displaying a one on, one off pixel pattern in a first column of a plurality of columns for a LED panel for the LED display; measuring a luminance and a color of the LED panel; calculating Red, Green, Blue color values for each LED in the first column; storing the Red, Green, Blue color values using a transformation matrix; determining a common voltage settling error map for each pixel in the first column; comparing the common voltage settling error map to a stored correction map for the first column to calculate a pixel specific correction; and generating the pixel specific correction.

In some implementations, process 1400 includes determining a plurality of zones for the LED display, wherein each zone comprises a portion of a plurality of lines of LEDs for the display and wherein the common voltage charge is being consistent within the zone.

In some implementations, process 1400 includes determining voltage correction value for a zone of the plurality of zones. The process 1400 can also applying the voltage correction value to the zone of the plurality of zones.

In some implementations, process 1400 includes determining a scaling factor for each zone of the plurality of zones, wherein the scaling factor is being based at least in part on a distance from the each zone to a common voltage buffer; and applying the scaling factor to the each zone of the plurality of zones.

In some implementations, a LED pattern comprises N LEDs on and M LEDs off, wherein N and M are non-zero integer values. In various embodiments, N, M can be 1, 3, 5, 7, etc. For example, in various embodiments N is one and M is one. In other embodiments, N is one and M is three. With the toggle pattern detection scheme, the patterns that can be identified can include 1onl1off, 1on3off, 1on5off, . . . ; 3on1off, 3on3off, 3on5off, . . . ; 5on1off, 5on3off, 5on5off, . . . ; 7on1off, 7on3off, 7on5off.

In some implementations, the predetermined toggle pattern is three LEDs on and three LEDs off. In some implementations, the predetermined threshold occurs in a range between +5 volts and −5 volts.

Although FIG. 14 shows example steps of process 1400, in some implementations, process 1400 can include additional steps, fewer steps, different steps, or differently arranged steps than those depicted in FIG. 14. Additionally, or alternatively, two or more of the steps of process 1400 can be performed in parallel.

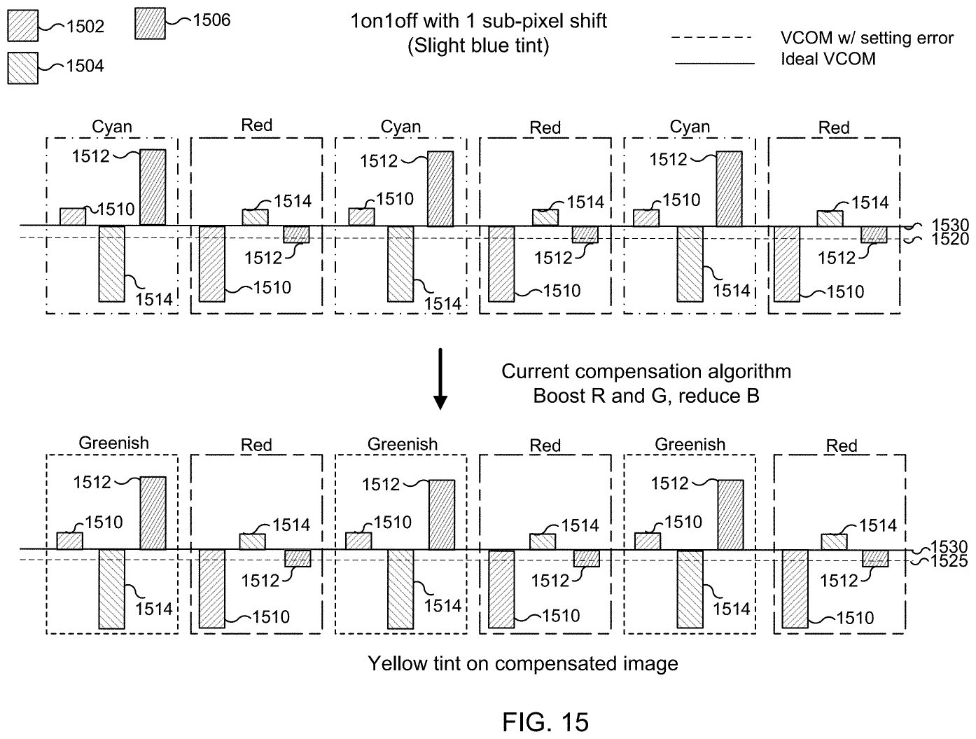

FIG. 15 illustrates an example compensation voltage patterns for a one on and one off LED pattern using a 1 subpixel shift. As shown in FIG. 15 the red subpixel voltage 1510 for the red subpixels 1502 and the blue subpixel voltage 1512 for the blue subpixels 1506 can alternate between positive polarity and negative polarity. The green subpixel voltage 1514 for the green subpixels 1504 can alternative between negative polarity and positive polarity. The common voltage with settling error 1520 is slightly lower than the ideal common voltage 1530 resulting the blue tint on the display.

A strategy to overcome the blue tint is to apply a current compensation algorithm that boosts the red subpixel voltage 1510 and the green subpixel voltage 1514 while reducing the blue subpixel voltage 1512. The resulting common voltage with settling error 1525 is closer to the ideal common voltage 1530. This can result in a slight yellow tin on the compensated image.

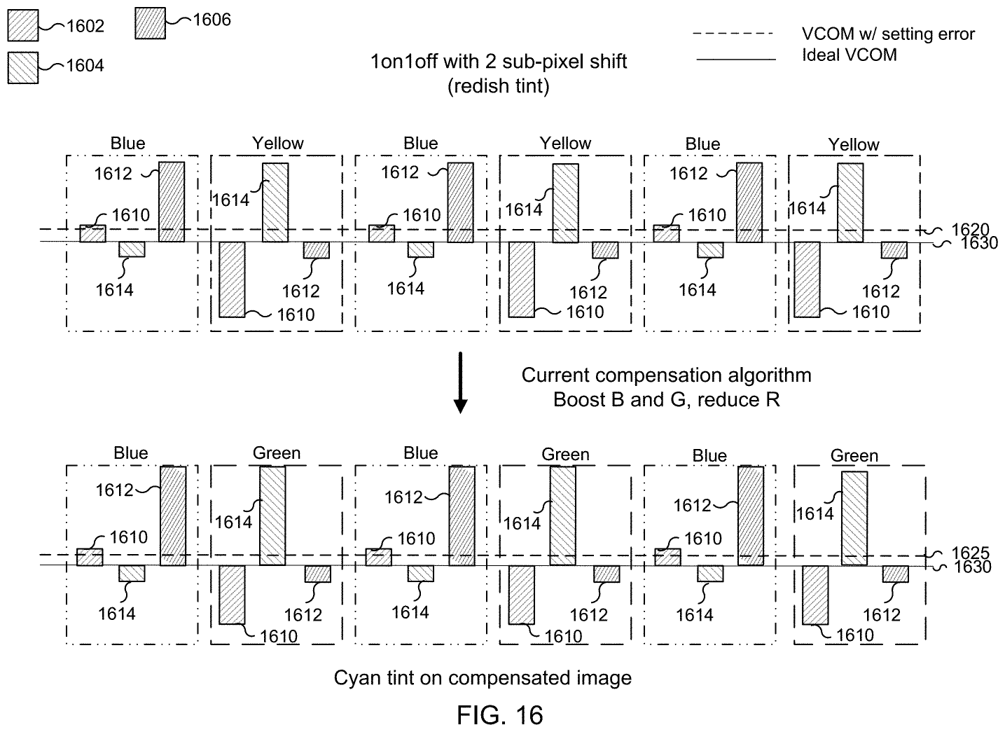

FIG. 16 illustrates an example compensation voltage patterns for a one on and one off LED pattern using a 2 subpixel shift. As shown in FIG. 16 the red subpixel voltage 1610 for the red subpixels 1602 and the blue subpixel voltage 1612 for the blue subpixels 1606 can alternate between positive polarity and negative polarity. The green subpixel voltage 1614 for the green subpixels 1604 can alternative between negative polarity and positive polarity. The common voltage with settling error 1620 is slightly higher than the ideal common voltage 1630 resulting in a reddish tint on the display.

A strategy to overcome the red tint is to apply a current compensation algorithm that boosts the blue subpixel voltage 1612 and the green subpixel voltage 1614 while reducing the red subpixel voltage 1610. The resulting common voltage with settling error 1625 is closer to the ideal common voltage 1630. This can result in a slight cyan tin on the compensated image.

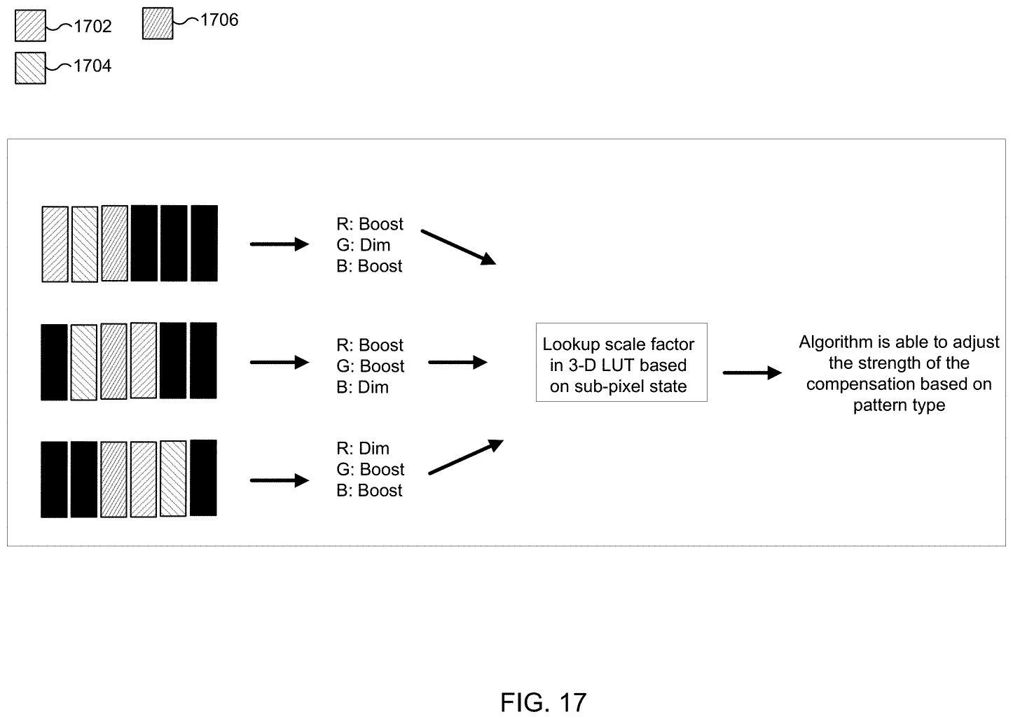

FIG. 17 illustrates an example corresponding technique for LED compensation pattern based on the pattern type. A first pattern 1710 is a one on and one off pattern with no sub-pixel shift. A second pattern 1720 is a one on and one off pattern with a 1 subpixel shift. A third pattern 1730 is a one on and one off patter with a 2 subpixel shift. The compensation for the first pattern 1710 is to boost red subpixel voltage and blue subpixel voltage and to reduce the green subpixel voltage. The compensation for the second pattern 1720 is to boost the red subpixel voltage and the green subpixel voltage and reduce the blue subpixel voltage. The compensation for the third pattern 1730 is to reduce the red subpixel voltage and to boost the green subpixel voltage and the blue subpixel voltage.

The voltage compensation algorithm can use 3D lookup tables to determine a scale factor based on the sub-pixel state. 3D LUTs can be used to map one color space to another. They can be used to calculate preview colors for a monitor or digital projector of how an image will be reproduced on another display device, typically the final digitally projected image or release print of a movie. A 3D LUT is a 3D lattice of output red green blue (RGB) color values that can be indexed by sets of input RGB color values. Each axis of the lattice represents one of the three input color components and the input color thus defines a point inside the lattice. Since the point may not be on a lattice point, the lattice values must be interpolated; most products use trilinear interpolation.

The voltage compensation algorithm can adjust the strength of the compensation based on the pattern type.

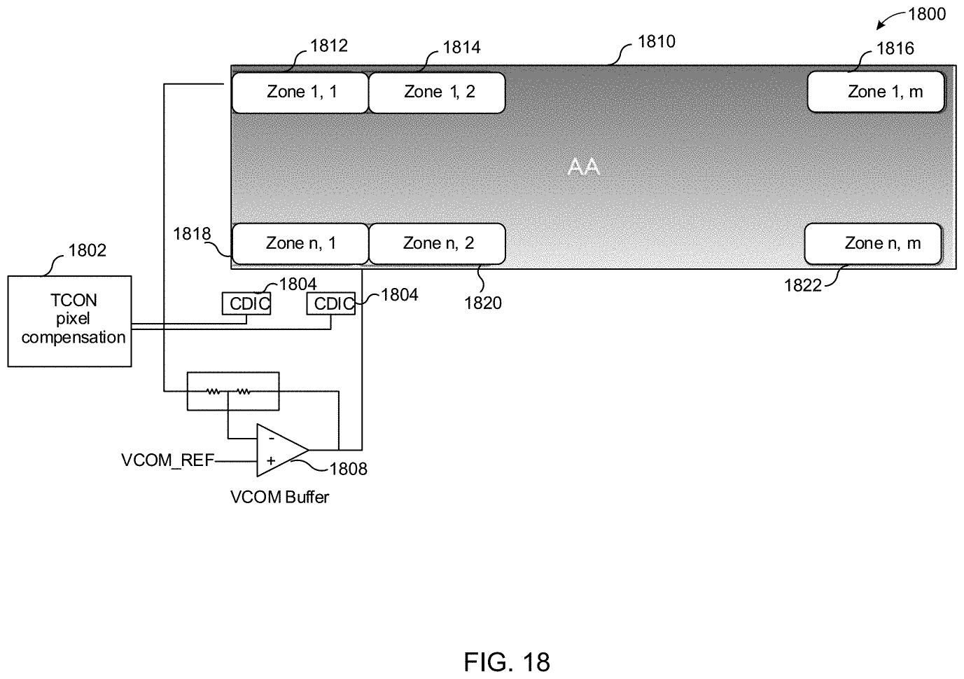

FIG. 18 illustrates a LED display 1800 divided into a number of zones. FIG. 18 illustrates a Timing Controller (TCON) 1802. The TCON 1802 can control the logic signal of gate and source for driving the LEDs. The TCON 1802 can also be known as the controller board or control board. The TCON 1802 can calculate the correction voltage in volts and then covert the voltage to a corresponding gray level. The gray level correction is sent from the TCON 1802 to the Column Driver Integrated Circuit (CDIC) 1804. The VCOM buffer 1808 receives the correction to be applied for particular zones of the display.

An LCD panel has millions of Red, Green, and Blue (RGB) liquid crystals that are used to block a white backlight when electrical voltage is applied to them. Other color liquid crystals can be used. High voltage signals to each individual pixel control how much of the backlight to block. A white display means nothing is being blocked. A black display means all three colors are blocked at maximum effort. The strength of the filtering determines the Contrast Ratio. The brightness of the backlight determines the intensity of the display. Varying levels of filtering produce the different colors. The speed of the voltage adjustment affects the pixel response time. The TCON 1802 can direct the high voltage driver chips that move the color filters.

As shown in FIG. 18 the LED display can be divided into various zones, each with varying degrees of the visual artifact. The zones can be identified by horizontal (line)(n) and vertical(column)(m) locations on the LED display 1800. For example, Zone (1,1) 1812 is in upper left corner of the display 1800. Zone (1,2) 1814 is adjacent to Zone (1,1) 1812. The zones continue across the display to Zone (1,m) 1816. Similarly, Zone (n,1) 1818 is located the bottom left side of display 1800. Zone (n,2) 1820 is located adjacent to Zone (n,1). Zone (n,m) 1822 is located in the bottom right corner of the display. The shading on the LED display 1800 can represent the varying degree of visual artifact (e.g., green tint) on the LED display 1800. In some zones (e.g., Zone (1,1) 1812) the amount of visual artifact appears to be greater than other zones on the display (e.g., Zone (n,m) 1822). This can be due to the location of the VCON buffers (e.g., VCON buffer 1808). VCON buffer 1808 applies the voltage correction to the LEDs in Zone (n,1) 1818 and therefore the amount of visual artifact can be less than other regions of the display (e.g., Zone (1,m) 1816).

By dividing the display 1800 into various zones, the correction may not need to be applied to the entire display 1800. The system can determine the particular zones with greater voltage settling error values and apply the correction to those zones. The size and number of LEDs in each zone can vary by display model. While the VCOM settling error is calculated for each line of the LED display 1800, the correction may be applied to various zones.

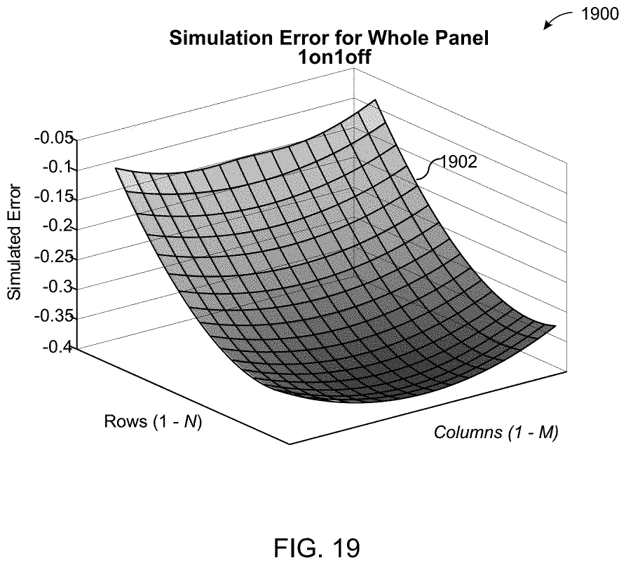

FIG. 19 illustrates simulation error graph 1900 for a one on and one off pattern. The graph 1900 plots the VCOM settling error by rows and columns of the display. The simulated voltage settling error is shown to be between −0.05 volts and −0.4 volts. F. FIG. 19 illustrates that the VCOM settling error will vary by the position (row, column) of the LEDs on the display 1900. The simulation error plot 1900 combines the green LED plot and the red and blue LED plot. The resulting plot 1902 can be plotted by row and column. As can be shown in FIG. 19, the simulated voltage settling error is negative, resulting in a green tint on the display that varies by location on the display.

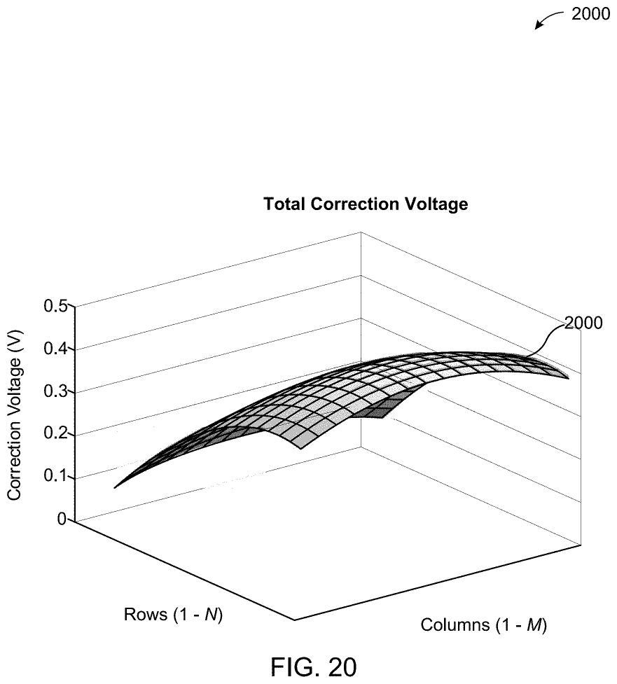

FIG. 20 illustrates the total correction voltage plot 2000 for a one on and one off display pattern. The total correction voltage plot 2000 is shown for various positions (row, column) of the LEDs on the display. The total correction voltage plot 2000 shows a correction voltage between 0 volts and 0.5 volts that can be applied based on the position (row, column) of the LEDs on the display. The total correction voltage plot 2000 can be generated by multiplying the simulated error of the simulation error graph 2200 by the panel response. In this way the voltage correction values can be shown for each LED position (row, column) on the display which corrects for the LED distance from the various VCOM buffers.

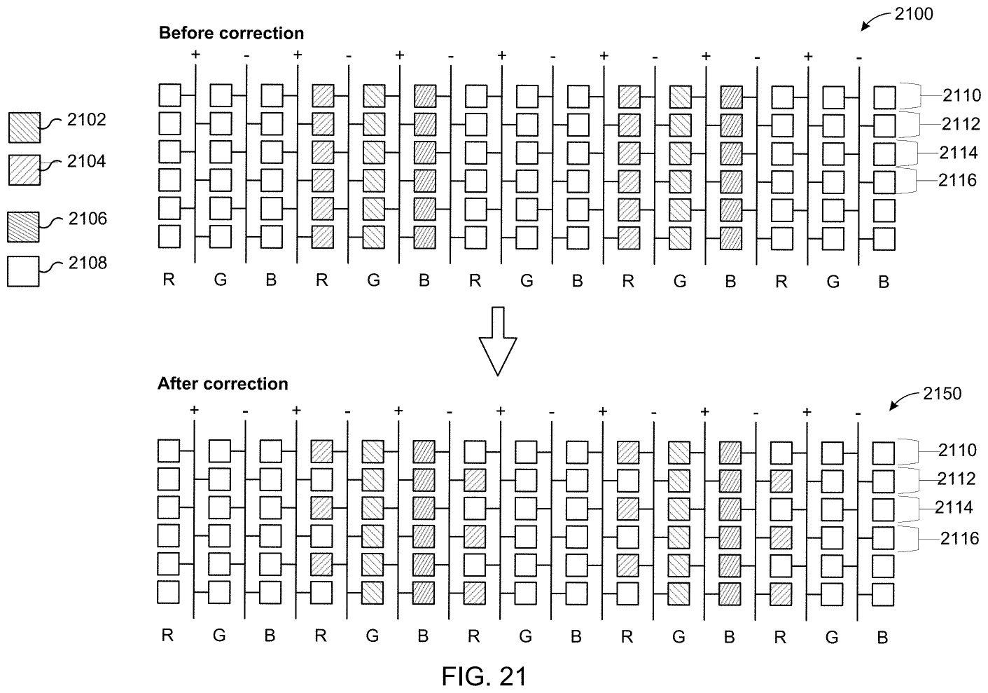

FIG. 21 illustrates a second technique for reducing the voltage settling error. In a second technique, the visual artifacts created by the VCOM settling error can be corrected by swapping various subpixels in the one on one off pattern. A first pattern 2100 illustrates an exemplary one on, one off pattern prior to any correction being applied. The first pattern 2100 illustrates the various connections for red subpixels 2102, green subpixels 2104, blue subpixels 2106, and off subpixels 2108 for a LED display. In the second technique, changes the location of the subpixels to eliminate the toggling itself that is the cause of the VCOM settling error. In the second technique, every two rows the red subpixels 2102 is swapped to the pixel to the right as shown in the second pattern 2150. For example, the first data line 2110 is unchanged between the first pattern 2100 and the second pattern 2150. In the second data line 2112, both red subpixels 2102 are shifted to the pixel to the right after correction. In the third data line 2114, the pattern is unchanged. In the fourth data line 2116, both red subpixels 2102 are again shifted to the pixel to the right.

Because of the shifting of the red subpixels 2102 every other row, there is no data toggling anymore. After correction, the red subpixels 2102 are connected to a blue subpixel 2106, so there is no toggling. This will eliminate the toggling and the VCOM settling error and corresponding color artifact.

This shifting can be accomplished through an algorithm in the display controller. This shifting of subpixels may result in slight distortion of the pattern.

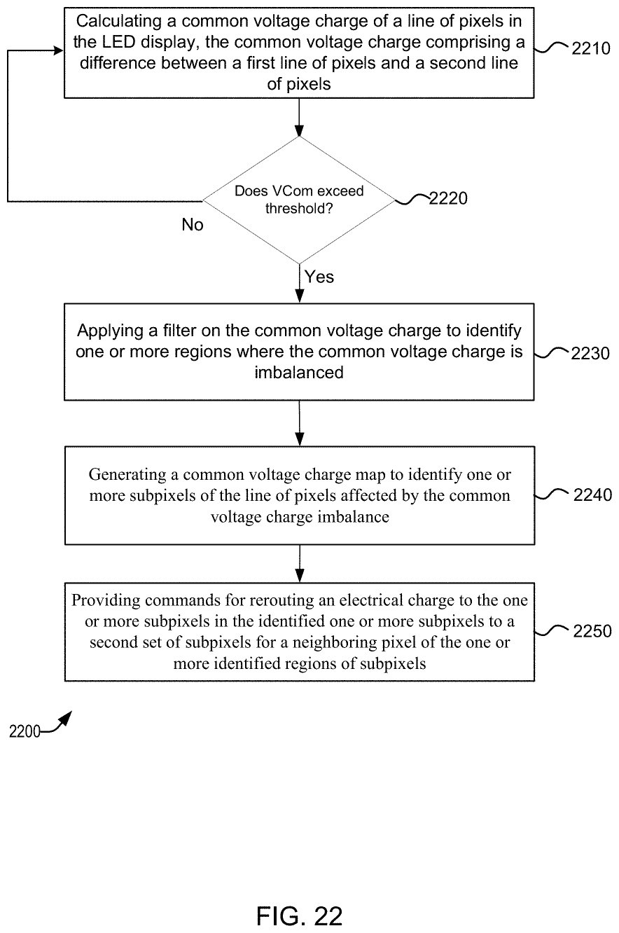

FIG. 22 is a flow chart of a second exemplary process 2200 for techniques for mitigating display artifacts caused by common voltage settling error. In some implementations, one or more process blocks of FIG. 22 can be performed by a display control system. In some implementations, one or more process blocks of FIG. 22 can be performed by another device or a group of devices separate from or including the display control system.

At 2210, process 2200 can include calculating a common voltage charge of a line of pixels in the LED display, the common voltage charge comprising a difference between a first line of pixels and a second line of pixels. For example, the display control system (e.g., using system circuitry 608, a graphics processing unit 612, a timing controller 614, column drivers 602 and gate drivers 603 and/or the like as illustrated in FIG. 6 and described above) can calculate a common voltage charge of a line of pixels in the LED display, the common voltage charge comprising a difference between a first line of pixels and a second line of pixels, as described above.

At 2220, process 2200 can include determining if the calculated common voltage charge exceeds a predetermined threshold. For example, the display control system (e.g., using system circuitry 608, a graphics processing unit 612, a timing controller 614, column drivers 602 and gate drivers 603 and/or the like as illustrated in FIG. 6 and described above) can determine if the calculated common voltage charge exceeds a predetermined threshold, as described above.

At 2230, process 2200 can include when the common voltage charge exceeds the predetermined threshold: applying a filter on the common voltage charge to identify one or more regions where the common voltage charge is imbalanced.

In various embodiments, the process 2200 can include generating a toggle matrix for the line of pixels, the toggle matrix comprising a matrix of charge values generated by calculating a difference in charge values for each subpixel a first line of subpixels with each subpixel a second line of subpixels, and wherein the first line of subpixels is adjacent the second line of subpixels. For example, the display control system (e.g., using system circuitry 608, a graphics processing unit 612, a timing controller 614, column drivers 602 and gate drivers 603 and/or the like as illustrated in FIG. 6 and described above) can when the common voltage charge exceeds the predetermined threshold, as described above. In some implementations, the first line of subpixels is adjacent the second line of subpixels.

At 2240, process 2200 can include searching the matrix of charge values for a predetermined toggle pattern to identify one or more regions of subpixels exhibiting the predetermined toggle pattern. For example, the display control system (e.g., using system circuitry 608, a graphics processing unit 612, a timing controller 614, column drivers 602 and gate drivers 603 and/or the like as illustrated in FIG. 6 and described above) can search the matrix of charge values for a predetermined toggle pattern to identify one or more regions of subpixels exhibiting the predetermined toggle pattern, as described above.

At 2250, process 2200 can include providing commands for rerouting an electrical charge to the one or more subpixels in the identified region of subpixels with the predetermined toggle pattern to a second set of subpixels for a neighboring pixel to the identified region of subpixels. For example, the display control system (e.g., using system circuitry 608, a graphics processing unit 612, a timing controller 614, column drivers 602 and gate drivers 603 and/or the like as illustrated in FIG. 6 and described above) can provide commands for rerouting an electrical charge to the one or more subpixels in the identified region of subpixels with the predetermined toggle pattern to a second set of subpixels for a neighboring pixel to the identified region of subpixels, as described above.

Process 2200 can include additional implementations, such as any single implementation or any combination of implementations described below and/or in connection with one or more other processes described elsewhere herein. It should be appreciated that the specific steps illustrated in FIG. 22 provide particular techniques for techniques for mitigating display artifacts caused by common voltage settling error according to various embodiments of the present disclosure. Other sequences of steps can also be performed according to alternative embodiments. For example, alternative embodiments of the present disclosure can perform the steps outlined above in a different order. Moreover, the individual steps illustrated in FIG. 22 can include multiple sub-steps that can be performed in various sequences as appropriate to the individual step. Furthermore, additional steps can be added or removed depending on the particular applications. One of ordinary skill in the art would recognize many variations, modifications, and alternatives.

In some implementations, the predetermined threshold occurs in a range between X and Y volts. In some implementations, the predetermined toggle pattern is one LED on and one LED off. In some implementations, the predetermined toggle pattern is one LED on and three LEDs off. In some implementations, the predetermined toggle pattern is three LEDs on and three LEDs off. In some implementations, the rerouting of the electrical charge to the one or more subpixels occurs for red subpixels in the identified region.

Although FIG. 22 shows example steps of process 2200, in some implementations, process 2200 can include additional steps, fewer steps, different steps, or differently arranged steps than those depicted in FIG. 22. Additionally, or alternatively, two or more of the steps of process 2200 can be performed in parallel.

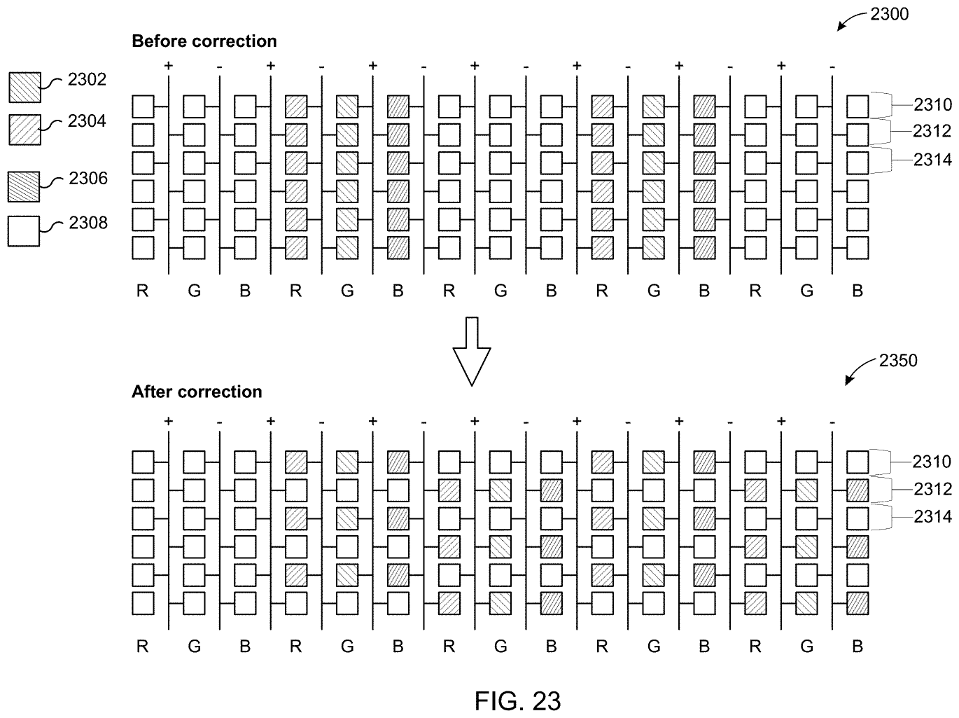

FIG. 23 illustrates a third technique for reducing the voltage settling error. In a third technique, the visual artifacts created by the VCOM settling error can be corrected by swapping various pixels in the one on one off pattern. In this technique, instead of just swapping the red subpixels 2302 as with the second technique, the entire pixel is swapped every other row.

A first pattern 2300 illustrates an exemplary one on, one off pattern prior to any correction being applied. The first pattern 2300 illustrates the various connections for red subpixels 2302, green subpixels 2304, blue subpixels 2306, and off subpixels 2308 for a LED display. In the third technique, changes the location of the pixels can eliminate the toggling itself that is the cause of the VCOM settling error. In the third technique, the entire pixel (include red subpixel 2302, green subpixel 2304, and blue subpixel 2306) is swapped with the pixel to the right as shown in the second pattern 2350. For example, the first data line 2310 is unchanged between the first pattern 2300 and the second pattern 2350. In the second data line 2312, the red subpixel 2302, the green subpixel 2304, and blue subpixel 2306 are shifted to the pixel to the right after correction. In the third data line 2314, the pattern is unchanged. In the fourth data line 2316, the red subpixel 2302, the green subpixel 2304, and blue subpixel 2306 are shifted to the pixel to the right after correction. This results in a “checkerboard” appearance for the LEDs.

Because of the shifting of the red subpixel 2302, the green subpixel 2304, and blue subpixel 2306 every other row, the toggling would be fully balanced resulting in no VCOM settling error and corresponding color artifact. On the second data line 2312 the green subpixel 2304 is toggling but it is a positive polarity but the neighboring blue subpixel 2306 is toggling as well. The neighboring blue subpixel is negative polarity therefore the toggling cancels out the toggling eliminating the VCOM settling error. The same number of positive polarity pixels are toggling as compared with the negative polarity pixels that are toggling.

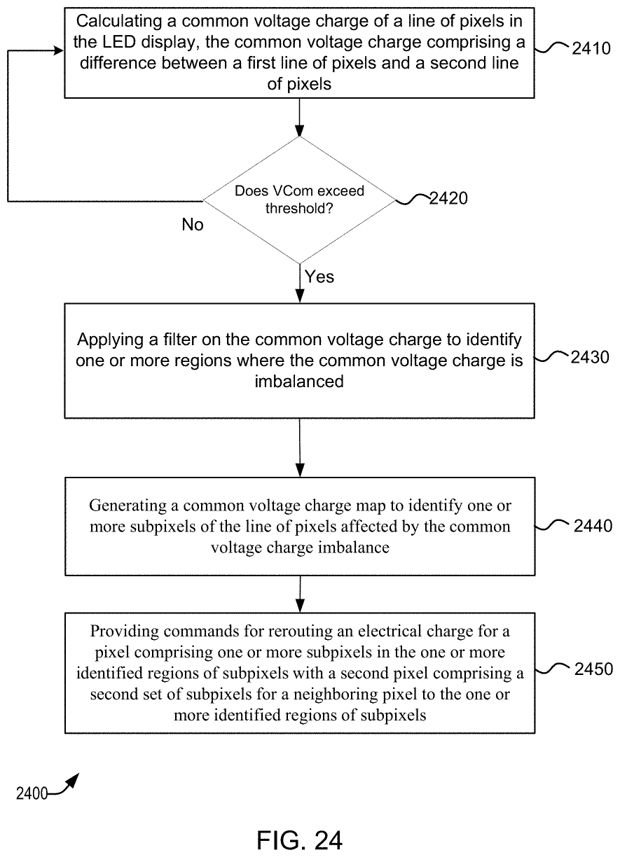

FIG. 24 is a flow chart of an example process 2400 for techniques for mitigating display artifacts caused by common voltage settling error. In some implementations, one or more process blocks of FIG. 24 can be performed by a display control system. In some implementations, one or more process blocks of FIG. 24 can be performed by another device or a group of devices separate from or including the display control system.

At 2410, process 2400 can include calculating a common voltage charge of a line of pixels in the LED display, the common voltage charge comprising a difference between a first line of pixels and a second line of pixels. For example, the display control system (e.g., using system circuitry 608, a graphics processing unit 612, a timing controller 614, column drivers 602 and gate drivers 603 and/or the like as illustrated in FIG. 6 and described above) can calculate a common voltage charge of a line of pixels in the LED display, the common voltage charge comprising a difference between a first line of pixels and a second line of pixels, as described above.

At 2420, process 2400 can include determining if the calculated common voltage charge exceeds a predetermined threshold. For example, the display control system (e.g., using system circuitry 608, a graphics processing unit 612, a timing controller 614, column drivers 602 and gate drivers 603 and/or the like as illustrated in FIG. 6 and described above) can determine if the calculated common voltage charge exceeds a predetermined threshold, as described above.

At 2430, process 2400 can include when the common voltage exceeds the predetermined threshold: applying a filter on the common voltage charge to identify one or more regions where the common voltage charge is imbalanced.

In various embodiments, the process 2400 can include generating a toggle matrix for the line of pixels, the toggle matrix comprising a matrix of charge values generated by calculating a difference in charge values for each subpixel a first line of subpixels with each subpixel a second line of subpixels, and wherein the first line of subpixels is adjacent the second line of subpixels. For example, the display control system (e.g., using system circuitry 608, a graphics processing unit 612, a timing controller 614, column drivers 602 and gate drivers 603 and/or the like as illustrated in FIG. 6 and described above) can when the common voltage exceeds the predetermined threshold, as described above. In some implementations, the first line of subpixels is adjacent the second line of subpixels.

At 2440, process 2400 can include searching the matrix of charge values for a predetermined toggle pattern to identify one or more regions of subpixels exhibiting the predetermined toggle pattern. For example, the display control system (e.g., using system circuitry 608, a graphics processing unit 612, a timing controller 614, column drivers 602 and gate drivers 603 and/or the like as illustrated in FIG. 6 and described above) can search the matrix of charge values for a predetermined toggle pattern to identify one or more regions of subpixels exhibiting the predetermined toggle pattern, as described above.

At 2450, process 2400 can include providing commands for rerouting an electrical charge for a pixel comprising one or more subpixels in the identified region of subpixels with the predetermined toggle pattern to a second pixel comprising a second set of subpixels for a neighboring pixel to the identified region. For example, the display control system (e.g., using system circuitry 608, a graphics processing unit 612, a timing controller 614, column drivers 602 and gate drivers 603 and/or the like as illustrated in FIG. 6 and described above) can provide commands for rerouting an electrical charge for a pixel comprising one or more subpixels in the identified region of subpixels with the predetermined toggle pattern to a second pixel comprising a second set of subpixels for a neighboring pixel to the identified region, as described above.

Process 2400 can include additional implementations, such as any single implementation or any combination of implementations described below and/or in connection with one or more other processes described elsewhere herein. It should be appreciated that the specific steps illustrated in FIG. 24 provide particular techniques for techniques for mitigating display artifacts caused by common voltage settling error according to various embodiments of the present disclosure. Other sequences of steps can also be performed according to alternative embodiments. For example, alternative embodiments of the present disclosure can perform the steps outlined above in a different order. Moreover, the individual steps illustrated in FIG. 24 can include multiple sub-steps that can be performed in various sequences as appropriate to the individual step. Furthermore, additional steps can be added or removed depending on the particular applications. One of ordinary skill in the art would recognize many variations, modifications, and alternatives.

In some implementations, the predetermined threshold occurs in a range between X and Y volts. In some implementations, the predetermined toggle pattern is one LED on and one LED off. In some implementations, the predetermined toggle pattern is one LED on and three LEDs off. In some implementations, the predetermined toggle pattern is three LEDs on and three LEDs off

Although FIG. 24 shows example steps of process 2400, in some implementations, process 2400 can include additional steps, fewer steps, different steps, or differently arranged steps than those depicted in FIG. 24. Additionally, or alternatively, two or more of the steps of process 2400 can be performed in parallel.

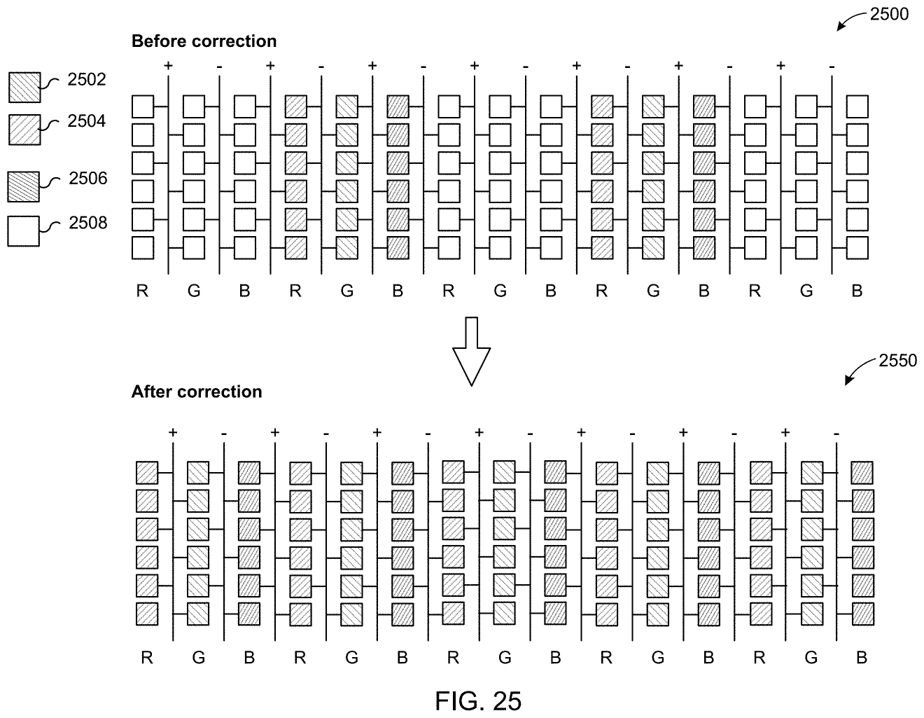

FIG. 25 illustrates a fourth technique for compensating for voltage settling error. In a fourth technique, the visual artifacts created by the VCOM settling error can be reduced by applying a filter for luminance filtering. In this technique, instead of swapping pixels or subpixels, a technique of luminance averaging can be applied to reduce or eliminate the VCOM settling error.

A first pattern 5300 illustrates an exemplary one on, one off pattern prior to any correction being applied. The first pattern 2500 illustrates the various connections for red subpixels 2502, green subpixels 2504, blue subpixels 2506, and off subpixels 2508 for a LED display.

Using a technique called low pass filtering, a filter can be applied to reduce and/or eliminate the VCOM settling charge. A low-pass filter (LPF) is a filter that passes signals with a frequency lower than a selected cutoff frequency and attenuates signals with frequencies higher than the cutoff frequency. The exact frequency response of the filter depends on the filter design. A 1D horizontal filter can be applied per each line on the pixels. The filter can eliminate the toggling imbalance in the LED pattern. After correction using the low pass filter, the off-on, off-on uncorrected pattern 2500, shown in FIG. 25 becomes a solid gray. Using the filter, every pixel illuminates an average luminance of every two pixels as shown in the corrected pattern 2550. By doing this, the pixels that are on are not as bright as the uncorrected pixels in the off-on, off-on uncorrected pattern 2500. The corrected pattern 2550 cab be an average of the uncorrected pattern 2500. By applying the low pass filtering techniques, there no longer exists high data toggling. All the pixels can have similar luminance values. This reduces the magnitude of data toggling and therefore reduces VCOM settling error due to charge imbalance. The low pass filtering can be performed in the master timing controller (e.g., TCON). These techniques can be incorporated into different types of displays or display technology.

The low pass filtering techniques can be applied once the VCOM settling error exceeds a predetermined threshold. Therefore, low pass filtering is a binary process. It can be applied if the VCOM settling error exceeds a threshold and not applied if the VCOM settling error does not exceed a threshold. This can be contrasted with the pixel-compensation techniques where the voltage correction applied can be proportional to the VCOM settling error.

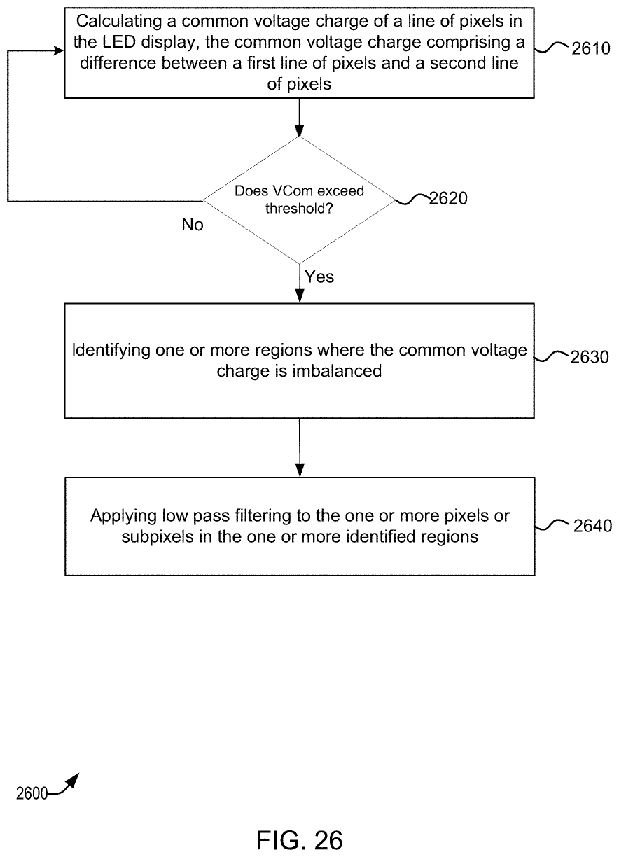

FIG. 26 is a flow chart of an example process 2600 for techniques for mitigating display artifacts caused by common voltage settling error. In some implementations, one or more process blocks of FIG. 26 can be performed by a display control system. In some implementations, one or more process blocks of FIG. 26 can be performed by another device or a group of devices separate from or including the display control system.

At 2610, process 2600 can include calculating a common voltage charge of a line of pixels in the LED display, the common voltage charge comprising a difference between a first line of pixels and a second line of pixels. For example, the display control system (e.g., using system circuitry 608, a graphics processing unit 612, a timing controller 614, column drivers 602 and gate drivers 603 and/or the like as illustrated in FIG. 6 and described above) can calculate a common voltage charge of a line of pixels in the LED display, the common voltage charge comprising a difference between a first line of pixels and a second line of pixels, as described above.

At 2620, process 2600 can include determining if the calculated common voltage charge exceeds a predetermined threshold. For example, the display control system (e.g., using system circuitry 608, a graphics processing unit 612, a timing controller 614, column drivers 602 and gate drivers 603 and/or the like as illustrated in FIG. 6 and described above) can determine if the calculated common voltage charge exceeds a predetermined threshold, as described above.

At 2630, process 2600 can include identifying one or more regions where the common voltage charge is imbalanced. Process 2600 can include applying a filter on the common voltage charge to identify one or more regions where the common voltage charge is imbalanced.

According to some implementations, a process 2600 may include calculating a common voltage charge of a line of pixels in the LED display, the common voltage charge comprising a difference between a first line of pixels and a second line of pixels; determining if the calculated common voltage charge exceeds a predetermined threshold; when the common voltage charge exceeds the predetermined threshold: generating a toggle matrix for the line of pixels, the toggle matrix comprising a matrix of charge values generated by calculating a difference in charge values for each subpixel a first line of subpixels with each subpixel a second line of subpixels wherein the first line of subpixels is adjacent the second line of subpixels; searching the matrix of charge values for a predetermined toggle pattern to identify one or more regions of pixels or subpixels exhibiting the predetermined toggle pattern; and providing commands for rerouting an electrical charge to the one or more pixels or subpixels in the identified region of subpixels with the predetermined toggle pattern to a second set of subpixels for a neighboring pixel to the identified region of subpixels.

In various embodiments, the process 2600 can include generating a toggle matrix for the line of pixels, the toggle matrix comprising a matrix of charge values generated by calculating a difference in charge values for each subpixel a first line of subpixels with each subpixel a second line of subpixels, and wherein the first line of subpixels is adjacent the second line of subpixels. For example, the display control system (e.g., using system circuitry 608, a graphics processing unit 612, a timing controller 614, column drivers 602 and gate drivers 603 and/or the like as illustrated in FIG. 6 and described above) can when the common voltage exceeds the predetermined threshold, as described above. In some implementations, the first line of subpixels is adjacent the second line of subpixels.

Process 2600 can include searching the matrix of charge values for a predetermined toggle pattern to identify one or more regions of subpixels exhibiting the predetermined toggle pattern. For example, the display control system (e.g., using system circuitry 608, a graphics processing unit 612, a timing controller 614, column drivers 602 and gate drivers 603 and/or the like as illustrated in FIG. 6 and described above) can search the matrix of charge values for a predetermined toggle pattern to identify one or more regions of subpixels exhibiting the predetermined toggle pattern, as described above.

At 2640, process 2600 can include applying low pass filtering to the one or more pixels or the subpixels in the identified region. For example, the display control system (e.g., using system circuitry 608, a graphics processing unit 612, a timing controller 614, column drivers 602 and gate drivers 603 and/or the like as illustrated in FIG. 6 and described above) can provide commands for filtering the electrical charge for the one or more pixels or subpixels in the identified region, as described above. The low pass filtering can perform luminance averaging across one or more pixels or subpixels. The average luminance can be an average of two neighboring pixels. The low pass filtering can reduce or eliminate residual common voltage that can produce undesirable display artifacts.

Process 2600 can include additional implementations, such as any single implementation or any combination of implementations described below and/or in connection with one or more other processes described elsewhere herein. It should be appreciated that the specific steps illustrated in FIG. 26 provide particular techniques for techniques for mitigating display artifacts caused by common voltage settling error according to various embodiments of the present disclosure. Other sequences of steps can also be performed according to alternative embodiments. For example, alternative embodiments of the present disclosure can perform the steps outlined above in a different order. Moreover, the individual steps illustrated in FIG. 26 can include multiple sub-steps that can be performed in various sequences as appropriate to the individual step. Furthermore, additional steps can be added or removed depending on the particular applications. One of ordinary skill in the art would recognize many variations, modifications, and alternatives.

In some implementations, the predetermined threshold occurs in a range between X and Y volts. In some implementations, the predetermined toggle pattern is one LED on and one LED off. In some implementations, the predetermined toggle pattern is one LED on and three LEDs off. In some implementations, the predetermined toggle pattern is three LEDs on and three LEDs off.

Although FIG. 26 shows example steps of process 2600, in some implementations, process 2600 can include additional steps, fewer steps, different steps, or differently arranged steps than those depicted in FIG. 26. Additionally, or alternatively, two or more of the steps of process 2600 can be performed in parallel.

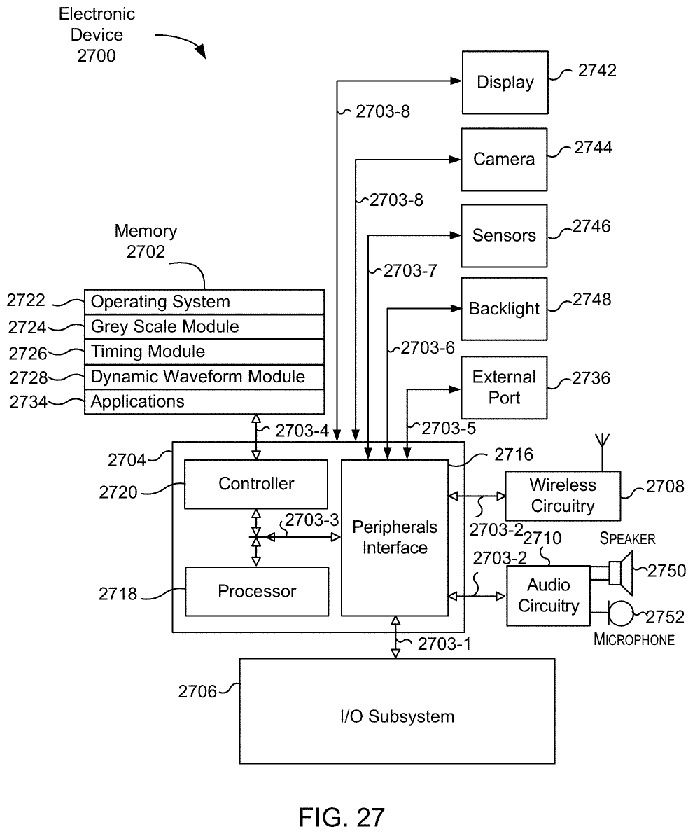

FIG. 27 is a block diagram of an example electronic device 2700. Device 2700 can include a computer-readable medium 2702, a processing system 2704, an Input/output (I/O) subsystem 2706, wireless circuitry 2708, and audio circuitry 2710 including speaker 2712. The electronic device can optionally include a microphone 2714. These components may be coupled by one or more communication buses or signal lines 2703. Device 2700 can be a liquid crystal display, any portable electronic device, including a handheld computer, a tablet computer, a mobile phone, laptop computer, tablet device, a media player, a personal digital assistant (PDA), a portable gaming device, or the like, including a combination of two or more of these items.

It should be apparent that the architecture shown in FIG. 27 is only one example of an architecture for device 2700, and that device 2700 can have more or fewer components than shown, or a different configuration of components. The various components shown in FIG. 27 can be implemented in hardware, software, or a combination of both hardware and software, including one or more signal processing and/or application specific integrated circuits.

Wireless circuitry 2708 is used to send and receive information over a wireless link or network to one or more other devices' conventional circuitry such as an antenna system, a radio frequency (RF) transceiver, one or more amplifiers, a tuner, one or more oscillators, a digital signal processor, a coder-decoder (CODEC) chipset, memory, etc. Wireless circuitry 2708 can use various protocols, e.g., as described herein. In various embodiments, wireless circuitry 2708 is capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), LTE-Advanced, Wi-Fi (such as Institute of Electrical and Electronics Engineers (IEEE) 802.11a, IEEE 802.11b, IEEE 802.11g and/or IEEE 802.11n), Bluetooth, Wi-MAX, Voice Over Internet Protocol (VoIP), near field communication protocol (NFC), a protocol for email, instant messaging, and/or a short message service (SMS), or any other suitable communication protocol, including communication protocols not yet developed as of the filing date of this document.

Wireless circuitry 2708 is coupled to processing system 2704 via peripherals interface 2716. Peripherals interface 2716 can include conventional components for establishing and maintaining communication between peripherals and processing system 2704. Voice and data information received by wireless circuitry 2708 (e.g., in speech recognition or voice command applications) is sent to one or more processors 2718 via peripherals interface 2716. One or more processors 2718 are configurable to process various data formats for one or more application programs 2734 stored on medium 2702.

Peripherals interface 2716 couple the input and output peripherals of device 2700 to the one or more processors 2718 and computer-readable medium 2702. One or more processors 2718 communicate with computer-readable medium 2702 via a controller 2720. Computer-readable medium 2702 can be any device or medium that can store code and/or data for use by one or more processors 2718. Computer-readable medium 2702 can include a memory hierarchy, including cache, main memory and secondary memory. The memory hierarchy can be implemented using any combination of random access memory (RAM) (e.g., static random access memory (SRAM,) dynamic random access memory (DRAM), double data random access memory (DDRAM)), read only memory (ROM), FLASH, magnetic and/or optical storage devices, such as disk drives, magnetic tape, CDs (compact disks) and DVDs (digital video discs). In some embodiments, peripherals interface 2716, one or more processors 2718, and controller 2720 can be implemented on a single chip, such as processing system 2704. In some other embodiments, they can be implemented on separate chips.

Processor(s) 2718 can include hardware and/or software elements that perform one or more processing functions, such as mathematical operations, logical operations, data manipulation operations, data transfer operations, controlling the reception of user input, controlling output of information to users, or the like. Processor(s) 2718 can be embodied as one or more hardware processors, microprocessors, microcontrollers, field programmable gate arrays (FPGAs), application-specified integrated circuits (ASICs), or the like.

Device 2700 also includes a power system 2742 for powering the various hardware components. Power system 2742 can include a power management system, one or more power sources (e.g., battery, alternating current (AC)), a recharging system, a power failure detection circuit, a power converter or inverter, a power status indicator (e.g., a light emitting diode (LED)) and any other components typically associated with the generation, management and distribution of power in mobile devices.

In some embodiments, device 2700 can include a camera 2744. In some embodiments, device 2700 includes sensors 2746. Sensors can include temperature sensors, accelerometers, compass, gyrometer, pressure sensors, audio sensors, light sensors, barometers, and the like. Sensors 2746 can be used to sense location aspects, such as auditory or light signatures of a location.

In some embodiments, device 2700 can include a backlight 2748 used to project light to illuminate the liquid crystal display.

One or more processors 2718 run various software components stored in medium 2702 to perform various functions for device 2700. In some embodiments, the software components include an operating system 2722, a grey scale module 2724, a timing module 2726, a dynamic waveform module 2728 and various applications 2734.

Operating system 2722 can be any suitable operating system, including iOS, Mac OS, Darwin, Real Time Operating System (RTXC), LINUX, UNIX, OS X, WINDOWS, or an embedded operating system such as VxWorks. The operating system can include various procedures, sets of instructions, software components, and/or drivers for controlling and managing general system tasks (e.g., memory management, storage device control, power management, etc.) and facilitates communication between various hardware and software components.

Grey Scale Module 2724 uses one or more fast photo detectors to determine the grey scale of various regions of images to be displayed.

The timing module 2726 can detect the driving frequency for the voltage holding ratio of the display. The timing module 2726 can synchronize the backlight waveform with the display waveform.

Dynamic Waveform Module 2728 can generate a backlight waveform that compensates for the drop in voltage holding ratio for various types of liquid crystal displays.

The one or more applications 2734 on device 2700 can include any applications installed on the device 2700, including without limitation, a browser, address book, contact list, email, instant messaging, social networking, word processing, keyboard emulation, widgets, JAVA-enabled applications, encryption, digital rights management, voice recognition, voice replication, a music player (which plays back recorded music stored in one or more files, such as MP3 or AAC files), etc.

There may be other modules or sets of instructions (not shown), such as a graphics module, a time module, etc. For example, the graphics module can include various conventional software components for rendering, animating and displaying graphical objects (including without limitation text, web pages, icons, digital images, animations and the like) on a display surface. In another example, a timer module can be a software timer. The timer module can also be implemented in hardware. The time module can maintain various timers for any number of events.

I/O subsystem 2706 can be coupled to a display system (not shown), which can be a touch-sensitive display. The display displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 2706 can include a display and user input devices such as a keyboard, mouse, and/or trackpad. In some embodiments, I/O subsystem 2706 can include a touch-sensitive display. A touch-sensitive display can also accept input from the user based at least part on haptic and/or tactile contact. In some embodiments, a touch-sensitive display forms a touch-sensitive surface that accepts user input. The touch-sensitive display/surface (along with any associated modules and/or sets of instructions in computer-readable medium 2702) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, I/O subsystem 2706 can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, device 2700 can include a touchpad (not shown) for activating or deactivating particular functions. In some embodiments, the touchpad is a touch-sensitive area of the device that, unlike the touch screen, does not display visual output. The touchpad can be a touch-sensitive surface that is separate from the touch-sensitive display or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. Any such computer readable medium may reside on or within a single computer product (e.g. a solid state drive, a hard drive, a CD, or an entire computer system), and may be present on or within different computer products within a system or network. A computer system may include a monitor, printer, or other suitable display for providing any of the results mentioned herein to a user.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the present disclosure has been described with respect to specific embodiments, it will be appreciated that the disclosure is intended to cover all modifications and equivalents within the scope of the following claims.

All patents, patent applications, publications, and descriptions mentioned herein are incorporated by reference in their entirety for all purposes. None is admitted to be prior art.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure. The use of “or” is intended to mean an “inclusive or,” and not an “exclusive or” unless specifically indicated to the contrary. Reference to a “first” component does not necessarily require that a second component be provided. Moreover reference to a “first” or a “second” component does not limit the referenced component to a particular location unless expressly stated. The term “based on” is intended to mean “based at least in part on.”

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

What is claimed is:

1. A method of operating a light emitting diode (LED) display, the method comprising:
calculating a common voltage charge of a line of pixels in the LED display, the common voltage charge comprising a difference between a first line of pixels and a second line of pixels;
determining if the calculated common voltage charge exceeds a predetermined threshold;
when the common voltage charge exceeds the predetermined threshold:
applying a filter on the common voltage charge to identify one or more regions where the common voltage charge is imbalanced;
generating a common voltage charge map to identify one or more subpixels of the line of pixels affected by the common voltage charge imbalance; and
generating a voltage correction charge based at least in part on a difference between a common voltage charge and an ideal common voltage charge; and
applying the voltage correction charge to the one or more regions of the display containing the one or more affected subpixels.

2. The method of claim 1, further comprising:
displaying a one on, one off pixel pattern in a first column of a plurality of columns for a LED panel for the display;
measuring a luminance and a color of the LED panel;
calculating Red, Green, Blue color values for each LED in the first column;
storing the Red, Green, Blue color values using a transformation matrix;
determining a common voltage settling error map for each pixel in the first column;
comparing the common voltage settling error map to a stored correction map for the first column to calculate a pixel specific correction; and
generating the pixel specific correction.

3. The method of claim 1, further comprising:
determining a plurality of zones for the LED display, wherein each zone comprises a portion of a plurality of lines of LEDs for the display and wherein the common voltage charge is consistent within the zone.

4. The method of claim 3, further comprising:
determining voltage correction value for a zone of the plurality of zones;
applying the voltage correction value to the zone.

5. The method of claim 3, further comprising:
determining a scaling factor for each zone of the plurality of zones, wherein the scaling factor is based at least in part on a distance from the each zone to a common voltage buffer; and
applying the scaling factor to the each zone of the plurality of zones.

6. The method of claim 1, further comprising:
generating a toggle matrix for the line of pixels, the toggle matrix comprising a matrix of charge values generated by calculating a difference in charge values for each subpixel of a first line of subpixels with each subpixel in a second line of subpixels, wherein the first line of subpixels is adjacent to the second line of subpixels; and
searching the matrix of charge values for a predetermined toggle pattern to identify one or more second regions of subpixels exhibiting the predetermined toggle pattern, wherein the identified one or more second regions comprise the one or more regions in which the common voltage charge is imbalanced.

7. The method of claim 1, wherein a LED pattern comprises N LEDs on and M LEDs off, wherein N and M are non-zero integer values.

8. The method of claim 7, wherein N is one and M is one.

9. The method of claim 7, wherein N is one and M is three.

10. A method of operating a light emitting diode (LED) display, the method comprising:
calculating a common voltage charge of a line of pixels in the LED display, the common voltage charge comprising a difference between a first line of pixels and a second line of pixels;
determining if the calculated common voltage charge exceeds a predetermined threshold;
when the common voltage charge exceeds the predetermined threshold:
applying a filter on the common voltage charge to identify one or more regions where the common voltage charge is imbalanced;
generating a common voltage charge map to identify one or more subpixels of the line of pixels affected by the common voltage charge imbalance; and
providing commands for rerouting an electrical charge to the one or more subpixels in the identified one or more subpixels to a second set of subpixels for a neighboring pixel of the one or more identified regions of subpixels.

11. The method of claim 10, further comprising:
generating a toggle matrix for the line of pixels, the toggle matrix comprising a matrix of charge values generated by calculating a difference in charge values for each subpixel of a first line of subpixels with each subpixel in a second line of subpixels, wherein the first line of subpixels is adjacent to the second line of subpixels; and
searching the matrix of charge values for a predetermined toggle pattern to identify one or more second regions of subpixels exhibiting the predetermined toggle pattern, wherein the identified one or more second regions comprise the one or more regions in which the common voltage charge is imbalanced.

12. The method of claim 10, wherein a LED pattern comprises N LEDs on and M LEDs off, wherein N and M are non-zero integer values.

13. The method of claim 12, wherein N is one and M is one.

14. The method of claim 12, wherein N is one and M is three.

15. The method of claim 10, wherein the rerouting of the electrical charge to the one or more subpixels occurs for red subpixels in the one or more identified regions.

16. A method of operating a light emitting diode (LED) display, the method comprising:
calculating a common voltage charge of a line of pixels in the LED display, the common voltage charge comprising a difference between a first line of pixels and a second line of pixels;
determining if the calculated common voltage charge exceeds a predetermined threshold;
when the common voltage exceeds the predetermined threshold:
applying a filter on the common voltage charge to identify one or more regions where the common voltage charge is imbalanced;
generating a common voltage charge map to identify one or more subpixels of the line of pixels affected by the common voltage charge imbalance; and
providing commands for rerouting an electrical charge for a pixel comprising one or more subpixels in the one or more identified regions of subpixels with a second pixel comprising a second set of subpixels for a neighboring pixel to the one or more identified regions of subpixels.

17. The method of claim 16, further comprising:
generating a toggle matrix for the line of pixels, the toggle matrix comprising a matrix of charge values generated by calculating a difference in charge values for each subpixel of a first line of subpixels with each subpixel in a second line of subpixels, wherein the first line of subpixels is adjacent to the second line of subpixels; and
searching the matrix of charge values for a predetermined toggle pattern to identify one or more second regions of subpixels exhibiting the predetermined toggle pattern, wherein the identified one or more second regions comprise the one or more regions in which the common voltage charge is imbalanced

18. The method of claim 16, wherein a LED pattern comprises N LEDs on and M LEDs off, wherein N and M are non-zero integer values.

19. The method of claim 18, wherein N is one and M is one.

20. The method of claim 18, wherein N is one and M is three.
